(19) United States
(12) Patent Application Publication
(10) Pub. No.: US 2026/0196874 A1
(43) Pub. Date: Jul. 9, 2026

(54) CHARGER DIAGNOSTICS AND UPDATES VIA A CHARGING INTERFACE

(71) Applicant: Oura Health Oy, Oulu (FI)

(72) Inventors: Sami Seppo Pelkonen, Oulu (FI); Kalle Juho Säippä, Oulu (FI); Tommi Matias Käsmä, Oulu (FI); Miika Petteri Kanste, Oulu (FI)

(21) Appl. No.: 19/011,953

(22) Filed: Jan. 7, 2025

(51) Int. Cl. H02J 50/10; G06F 8/65; H02J 7/00; H02J 50/40; H02J 50/80

(52) U.S. Cl. CPC H02J 50/10; G06F 8/65; H02J 7/731; H02J 50/80; H02J 50/402

(57) ABSTRACT

Methods, systems, and devices for charger diagnostics and updates via a charging interface are described. In some cases, a charger device detects that a wearable device is coupled with the charger device. The charger device charges the wearable device (e.g., via inductive charging mechanisms) while also sending charger diagnostic data. For example, the charger device outputs power to charge the wearable device during a charging session and outputs charger diagnostic data as part of the charging session. After the charger diagnostic data is sent, the charger continues to charge the wearable device with additional power.

### FIELD OF TECHNOLOGY

The following relates to wearable devices and data processing, including charger diagnostics and updates via a charging interface.

### BACKGROUND

Some wearable devices may be configured to collect data from users. Some wearable devices may be designed to include one or more elements that may facilitate charging via a charging device (e.g., a charger).

### BRIEF DESCRIPTION OF THE DRAWINGS

FIG. 1 shows an example of a system that supports charger diagnostics and updates via a charging interface in accordance with aspects of the present disclosure.

FIG. 2 shows an example of a process flow that supports charger diagnostics and updates via a charging interface in accordance with aspects of the present disclosure.

FIG. 3 shows an example of a timing diagram that supports charger diagnostics and updates via a charging interface in accordance with aspects of the present disclosure.

FIG. 4 illustrates an example of a system that supports charger diagnostics and updates via a charging interface in accordance with aspects of the present disclosure.

FIG. 5 illustrates an example of a system that supports charger diagnostics and updates via a charging interface in accordance with aspects of the present disclosure.

FIG. 6 shows a block diagram of an apparatus that supports charger diagnostics and updates via a charging interface in accordance with aspects of the present disclosure.

FIG. 7 shows a block diagram of a wearable application that supports charger diagnostics and updates via a charging interface in accordance with aspects of the present disclosure.

FIG. 11 shows a diagram of a system including a device that supports charger diagnostics and updates via a charging interface in accordance with aspects of the present disclosure.

FIG. 9 shows a block diagram of an apparatus that supports charger diagnostics and updates via a charging interface in accordance with aspects of the present disclosure.

FIG. 10 shows a block diagram of a wearable device manager that supports charger diagnostics and updates via a charging interface in accordance with aspects of the present disclosure.

FIG. 8 shows a diagram of a system including a device that supports charger diagnostics and updates via a charging interface in accordance with aspects of the present disclosure.

FIGS. 12 and 13 show flowcharts illustrating methods that support charger diagnostics and updates via a charging interface in accordance with aspects of the present disclosure.

### DETAILED DESCRIPTION

Wearable devices (e.g., rings, watches, etc.) may be used to measure biometric data of a user and report the data to the user. Wearable devices may generally be wireless devices, and may be charged via a charger device, such as an inductive or contact-based charging device. However, if there is an issue with charging the wearable device, current mechanisms may not enable users or customer service personnel to identify the issue. That is, conventional charging techniques may not enable users to identify whether any issue with charging is due to an issue with the wearable device, or an issue with the charger device itself.

Without the diagnostics capability to identify and/or display the charging issue, charger performance features may not be tracked, and the charger may not fully charge the battery of the wearable device, or may even damage the wearable device. Further, in cases where there is an issue with the charging device, current techniques may not enable the charging device to be remotely updated to address the issue within the charger. These issues may result in the wearable device failing to fully charge, or charging at reduced speeds (e.g., as compared to a “normal” or “standard” charging speed for the respective charger), until a replacement charger is received.

Problems with wearable device chargers may present particular issues in the context of finger-worn wearable ring devices. Specifically, unlike some other wearable devices such as smart watches, wearable ring devices may not include a display (e.g., screen) that can be used to flag charging issues to the user. Moreover, charger devices for wearable ring devices are often manufactured with a small size (relative to other wearable device chargers) that corresponds to the relatively small size of the wearable ring devices themselves. As such, the charger devices for such wearable ring devices have relatively little space to fit other communications circuitry/components that would otherwise be used to communicate information about charging issues. That is, larger charger devices (such as charger devices for smart watches) may have sufficient space to accommodate Bluetooth modules/chips that can be used to communicate information about charging issues, where charger devices for finger-worn devices may not include sufficient space to accommodate such Bluetooth chips. Further, wearable ring devices may include smaller batteries relative to other wearable devices (e.g., watches), where the smaller sized batteries may make it more difficult to run diagnostics diagnostics and/or resolve charging issues. That is, the smaller batteries of wearable ring devices may utilize smaller currents and/or voltages as compared to batteries of larger wearable devices, where the smaller currents/voltages may make it more difficult to identify charging issues. Left unaddressed, issues with the charging devices of such wearable ring devices may cause damage to the batteries and reduce the lifespan or longevity of the wearable ring device.

Techniques described herein use an inductive communication link between the charger and the wearable device that is designed to transfer charger diagnostic data (e.g., firmware version, inductive charging voltage, and the like) from the charger to the wearable device to track charger performance features. More specifically, techniques described herein may transmit charger diagnostic data to the wearable device during the charging process via the inductive link used for charging. During inductive charging, the charger modulates the charging power to transmit the charger diagnostic data while the wearable device is charging. That is, the inductive charging link may be used to simultaneously transmit power used for charging and charger diagnostic data. The wearable device then relays the charger diagnostic data to an application executed via a mobile device in order to identify potential issues with the charger. In some cases, the wearable device may communicate a request to the charger for charger diagnostic data. Further, the wearable device may communicate information to the charger via the inductive communication link (e.g., inductive charging link) in order to address potential issues, implement firmware updates, and the like.

Techniques described herein may track charger performance features and troubleshooting issues via the inductive communication link between the charger and the wearable device, thereby leading to more effective charging for the wearable device (e.g., faster charging, optimized charge signal, reduced or eliminated charging errors, and the like). Moreover, techniques described herein may enable firmware updates for the charger to be communicated to the charger via the inductive communication link. That is, aspects of the present disclosure may utilize the inductive charging link between the charger and the wearable device to exchange charger diagnostic data, firmware updates, etc. As such, by inductively communicating data between the charger and the wearable device via the inductive charging link, issues with the charger device may be identified, and the charger may be remotely updated without having to replace the charger itself, thereby increasing the overall user experience.

Further, by utilizing the inductive components of the charger to communicate charger diagnostic data, the charger device may be manufactured without additional communication circuitry (e.g., without separate Bluetooth modules), thereby reducing the manufacturing cost of the charger device (and corresponding wearable device). Thus, techniques described herein may enable charger devices that do not have sufficient room/space for separate communication circuitry (such as smaller charger devices for wearable ring devices) to utilize inductive components to communicate information regarding charger issues.

Aspects of the disclosure are initially described in the context of systems supporting physiological data collection from users via wearable devices. Aspects of the disclosure are further illustrated by and described with reference to process flow diagrams and timing diagrams. Aspects of the disclosure are further illustrated by and described with reference to apparatus diagrams, system diagrams, and flowcharts that relate to charger diagnostics and updates via a charging interface.

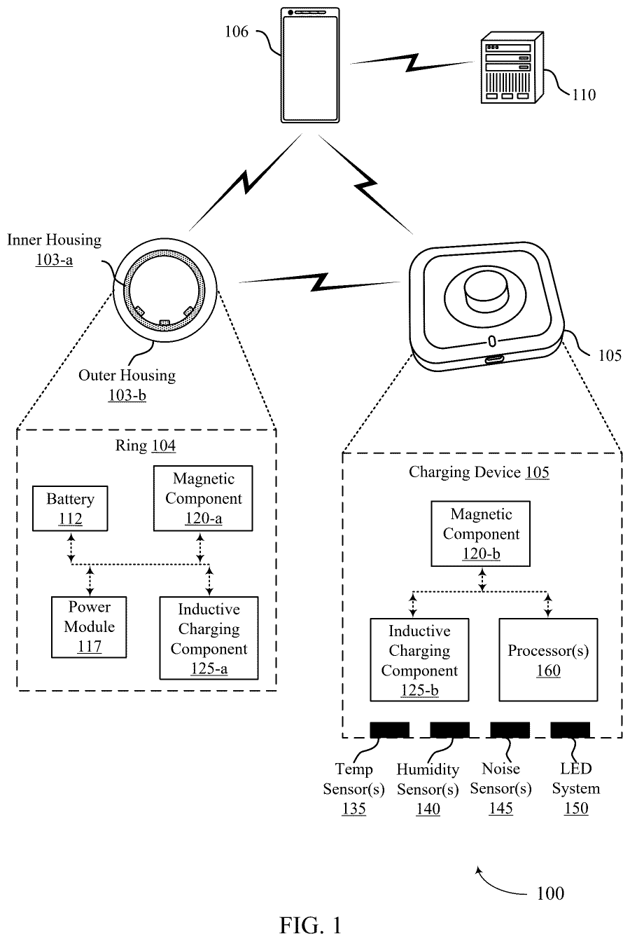

FIG. 1 shows an example of a system 100 that supports charger diagnostics and updates via a charging interface in accordance with aspects of the present disclosure. In particular, system 100 illustrates an example of a ring 104 (e.g., wearable device 104), as described herein, and a charging device 105.

In some aspects, the ring 104 may be configured to be worn around a user's finger and may measure one or more user physiological parameters when worn around the user's finger. Example measurements and determinations may include, but are not limited to, user skin temperature, pulse waveforms, respiratory rate, heart rate, HRV, blood oxygen levels, and the like.

The system 100 further includes a charging device 105. The ring 104 may be in wireless and/or wired communication with a user device 106 and/or server 110. Similarly, the charging device 105 may be in wireless and/or wired communication with a user device 106, the ring 104, a server 110, or any combination thereof. In some implementations, the charging device 105 may include one or more sensors that are configured to acquire data, such as one or more temperature sensors 135, one or more humidity sensors 140, one or more noise sensors 145, and the like. The charging device 105 may send measured and processed data (e.g., temperature data, humidity data, noise data, and the like) to the user device 106, the ring 104, or both. Various data processing procedures described herein may be performed by any of the components of system 100, including the ring 104, charging device 105, user device 106, server 110, or any combination thereof.

Data may be collected and analyzed via one or more components of the system 100. Moreover, in some implementations, the charging device 105 may be configured to collect and analyze data, including ambient temperature data, noise data, and the like. For example, the user device 106 may determine a correlation between sleep data from the ring 104 and the measured and processed data from the charging device 105 (e.g., if the air temperature is relatively high, a user of the ring 104 may wake up throughout a sleep duration). In other words, data collected via the charging device 105 (e.g., ambient air temperature data, noise data) may be used to further analyze physiological data collected via the ring 104.

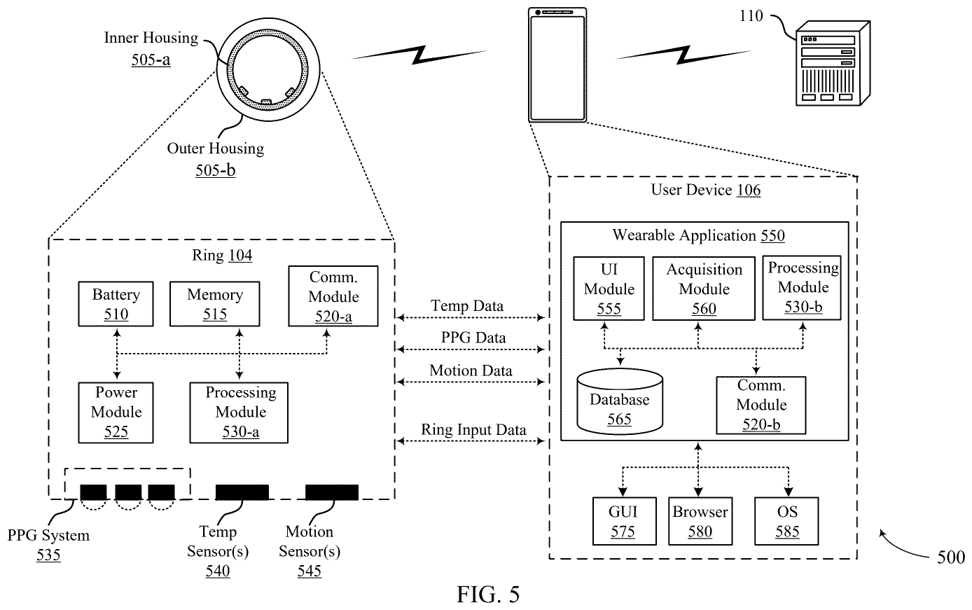

The ring 104 may include an inner housing 103-a and an outer housing 103-b (as further described with reference to FIG. 5). In some aspects, the housing 103 of the ring 104 may store or otherwise include various components of the ring 104 including, but not limited to, device electronics (e.g., a power module 117, which may be an example of a power module 525 as described with reference to FIG. 5), a power source (e.g., battery 112, which may be an example of a battery 510 as described with reference to FIG. 5, and/or capacitor), one or more substrates (e.g., printable circuit boards) that interconnect the device electronics and/or power source, and the like. In some examples, the housing 103 may also store a magnetic component 120-a (e.g., ferrite tape, other charging magnet, a transmitter coil, a rare earth magnet, or the like) and an inductive charging component 125-a.

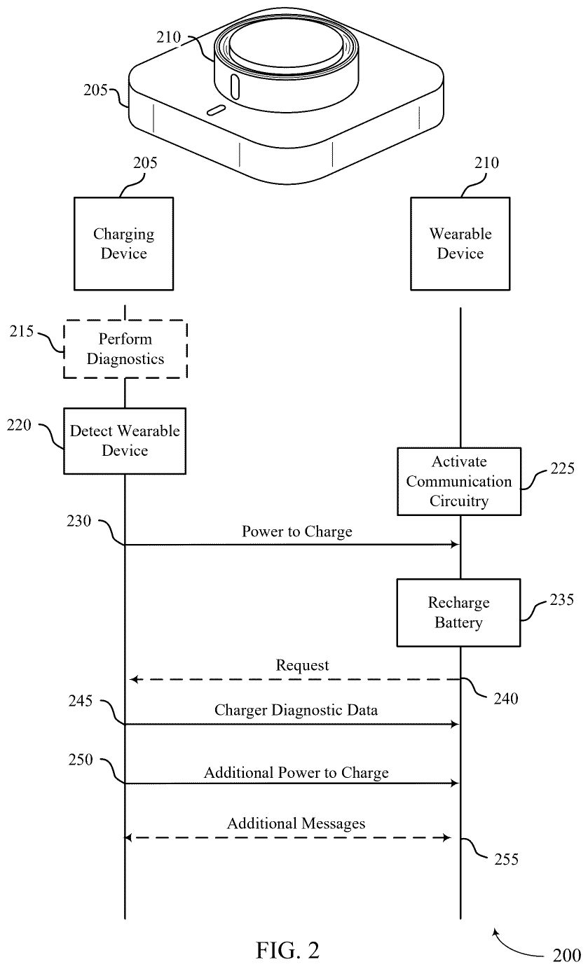

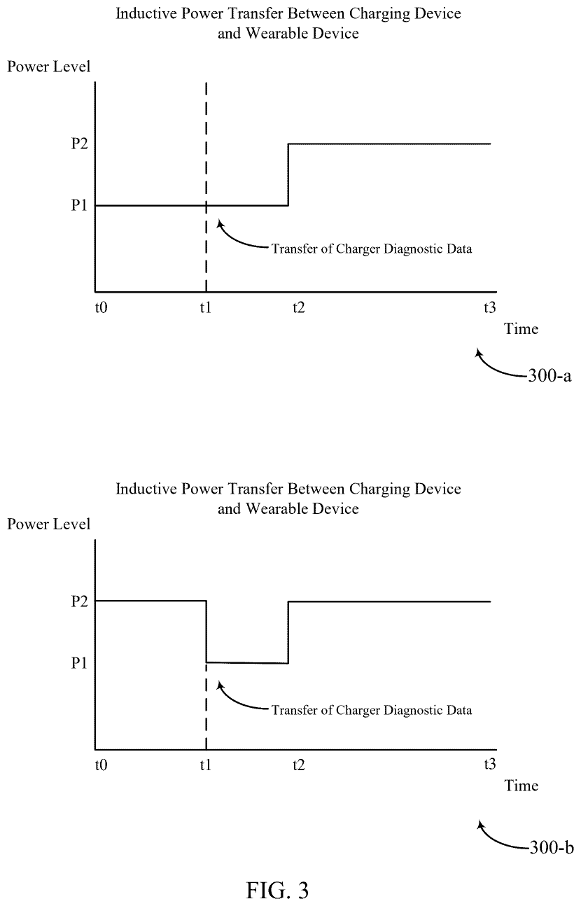

The ring 104 shown and described with reference to FIGS. 2 and 3 is provided solely for illustrative purposes. As such, the ring 104 may include additional or alternative components as those illustrated in FIGS. 2 and 3. Other rings 104 that provide functionality described herein may be fabricated. For example, rings 104 with fewer components (e.g., sensors) may be fabricated. In a specific example, a ring 104 may include ferrite tape, which may act as both the magnetic component 120-a and the inductive charging component 125-a. In other cases, the ring 104 may include a dedicated charger magnet. For example, the ring 104 may include a metal plate and/or ferrite tape disposed proximate to a charger magnet.

The ring 104 may be placed in a charging position that facilitates wireless charging between the inductive charging component 125-a of the ring 104 and the inductive charging component 125-b of the charging device 105. In some examples, the ring 104 and the charging device 105 may be configured with contact-based charging components such that an orientation facilitates current flow between the contact-based charging components of the ring 104 and the charging device 105.

In such cases, the ring 104 may be in electronic communication with the charging device 105 (e.g., via an inductive link between the inductive charging components 125-a, 125-b). The charging device 105 may charge the battery 112 of the ring 104. The charging device 105 may include a support (e.g., charging post), which may store or otherwise include various components of the charging device 105. That is, the ring 104 may be configured to at least partially surround the support/charging post of the charging device 105. In some aspects, the support/charging post of the charging device 105 may store or otherwise include various components of the charging device 105 including, but not limited to, a magnetic component 120-b (e.g., ferrite tape, a transmitter coil, a rare earth magnet, or the like) and an inductive charging component 125-b.

In some cases, the magnetic component 120-b of the charging device 105 may include multiple magnets arranged according to a pattern based on a polarity of each magnet. For example, each magnet may have a polarity facing outward towards the surface of the charging device 105 to attract the magnetic component 120-a of the ring 104 with an opposite polarity. The charging component 125-b of the charging device 105 (e.g., transmitter coil, ferrite tape) may couple with charging component 125-a of the ring 104 (e.g., receiver coil, ferrite tape) to charge the battery 112 of the ring 104. In some examples, the charging component 125-a and the charging component 125-b may support charging of the battery 112 via direct electrical coupling (e.g., of contacts at the surface of the charging device 105 and the ring 104). Additionally, or alternatively, the charging component 125-a and the charging component 125-b may be examples of inductive charging components, which may support charging of the battery 112 via indirect electrical coupling. Inductive charging may also be referred to as wireless charging and may allow power to transfer from the charging device 105 to the battery 112 of the ring 104 using electromagnetic induction.

In some examples, the charging device 105 may include one or more temperature sensors 135. The temperature sensors 135 may measure an average air temperature over a duration, may continuously measure air temperature, or both. Similarly, the charging device 105 may include one or more humidity sensors 140. The humidity sensors 140 may measure an average humidity level over a duration, may continuously measure humidity level, or both. The humidity sensors 140 may measure the humidity as a percentage (e.g., 35% humidity). The charging device 105 may include one or more noise sensors 145. The noise sensors 145 may measure a noise level (e.g., in decibels) averaged over a duration, continuously, or both. The charging device 105 may store the humidity measurements, the temperature measurements, the noise measurements, or a combination thereof.

The charging device 105 may include any type of sensor known in the art and may be configured to collect any type of data which may be used to provide insight into a user's environment and overall health. For example, the charging device 105 may include light sensors configured to measure an amount of light and/or type of light (e.g., wavelength). In such cases, the system 100 may be configured to determine whether light levels and/or which types of light may result positively or negatively affect a user's sleep and health (e.g., determine if blue light is more disruptive to a user's sleep as compared to red light). By way of another example, the charger base may include air quality sensors configured to measure air quality, pollutants, allergens, and the like. Data collected via sensors of the charger base may be leveraged to determine how a user's surrounding environment may affect their physiological data, sleep, and overall health. A processing module, such as a processing module 230 as described with reference to FIG. 2, at the user device 106 or at the charging device 105 may process the data from the temperature sensors 135, the humidity sensors 140, the noise sensors 145, light sensors, air quality sensors, or a combination thereof.

In some examples, the user device 106 and/or charging device 105 may process the data from the temperature sensors 135, the humidity sensors 140, the noise sensors 145, or a combination thereof in conjunction with data from the ring 104. For example, the user device 106 may receive physiological data collected by the ring 104 which reflects one or more sleep cycles of a user and may use the data from the sensors at the charging device 105 to determine a correlation between the collected physiological data and data collected by the charging device 105. For example, the user device 106 may determine a correlation over a time interval between data collected by the charging device 105 (e.g., ambient temperature data, humidity data, noise data, and the like) with a quality of sleep for the user (as determined by collected physiological data). In other words, the system 100 may be configured to identify whether high/low temperature, humidity, and/or noise levels result in a disruption of the user's sleep cycles (e.g., low ambient temperature and humidity levels result in higher quality sleep, higher noise levels result in lower quality sleep).

Although the charging device 105 is illustrated as including temperature sensors 135, humidity sensors 140, and noise sensors 145, the charging device 105 may include any quantity and type of sensors in one or more locations. For example, the charging device 105 may also include a motion sensor, a light sensor, or the like.

In some cases, the charging device 105 may include an LED system 150 (e.g., LED indicator lights, display screen, etc.). The LED system 150 may display one or more indications to a user of the ring 104. For example, the LED system 150 may display a battery level of the battery 112, a battery health/charge status (e.g., end of battery life), a time of day, connectivity issues, one or more scores of the user (e.g., a Sleep Score related to how well a user slept, a Readiness Score, an Activity Score, or the like). Additionally, or alternatively, the LED system 150 may display one or more alerts to the user (e.g., action items prompting the user to perform an action, and the like). The LED system 150 may display a battery level of the battery 112 of the ring 104 as a percentage of total battery by displaying the numbers of the percentage, by illuminating a portion of LEDs (e.g., if a battery level is at 50%, 5 of 10 LEDs may be displayed), or the like. The LEDs in the LED system 150 may be oriented in any arrangement on the charging device 105, may be any color combination (e.g., red LED, blue LED, green LED), and there may be any quantity of LEDs in the LED system 150.

In some implementations, the charging device 105 may include a wired or wireless power source. For example, in some cases, the charging device 105 may be coupled with an electrical outlet or other power source. In other cases, the charging device 105 may include a battery or other internal power source to enable mobile charging of the ring 104. For example, in some implementations, the charging device 105 may include a battery or other internal power source such that a user may physically wear or carry the charger along with the ring 104 for mobile charging. For instance, the charging device 105 may be worn on a necklace so that a user may wear the charger while simultaneously charging the ring 104. In other cases, the charging device 105 may be coupled with the ring 104 (e.g., magnetically coupled, mechanically snapped onto) the ring 104 while the ring 104 is being worn so that the ring 104 may be charged (and continue to collect physiological data) as it is worn.

According to some aspects of the present disclosure, the inductive charging components 125-a, 125-b may be used to form an inductive link between the ring 104 and charging device 105, where the inductive link may be used to (1) transfer power to the ring 104 to recharge the battery 112, (2) transfer charger diagnostic data from the charging device 105 to the ring 104, (3) communicate firmware updates from the ring 104 to the charging device 105 to update a firmware of the charging device 105, (4) transfer charger sensor data and/or other charger non-diagnostic data from the charging device 105 to the ring 104, and (5) communicate configurations and/or commands from the ring 104 to the charging device 105 to modify the behavior of the charging device 105.

By using an inductive charging link between the charging device 105 (e.g., charging device) and the ring 104 to transfer charger diagnostic data (e.g., firmware version, inductive charging voltage, and the like) from the charging device 105 to the ring 104, charger performance features may be tracked and issues may be troubleshooted via the inductive communication link. By inductively communicating charger diagnostic data between the charging device 105 and the ring 104, the charging device 105 may be remotely updated without having to replace the charging device 105 itself, thereby increasing the overall user experience and the ring 104 may be more effectively charged (e.g., faster charging, stronger charge signal, reduced or eliminated charging errors, and the like).

FIG. 2 shows an example of a process flow 200 that supports charger diagnostics and updates via a charging interface in accordance with aspects of the present disclosure. The process flow 200 illustrates and describes a communication process between a charging device 205 and a wearable device 210. In some examples, the communication process may involve transmitting charging diagnostic data between a charging device 205 and a wearable device 210. In some implementations, the process flow 200 may implement, or be implemented by, aspects of the system 100. The wearable device 210 (e.g., device, wearable ring device, ring) and the charging device 205 illustrated in FIG. 2 may be examples of the wearable device 104 (e.g., the ring 104) and the charging device 105, respectively, as described with reference to FIG. 1.

In the process flow 200, the operations between the wearable device 210 and the charging device 205 may be performed in different orders or at different times. Some operations may also be left out of the process flow 200, or other operations may be added. Although the charging device 205 and the wearable device 210 are shown performing the operations of the process flow 200, some aspects of some operations may also be performed by one or more other devices. For example, the wearable device 210 may be a wearable ring device or a wearable wrist-worn device.

As shown in FIG. 2, the charging device 205 may include a base and a support/charging post, where the wearable device 210 (e.g., ring) is configured to be placed around the charging post for charging. In this regard, the inductive charging components of the charging device 205 may be placed within or beneath an outer surface of the charging post, and the inductive charging components may be placed within or beneath an inner curved surface of the wearable device 210.

At 215, the charging device 205 may perform charger diagnostics. For example, the charging device 205 may perform one or more diagnostic procedures on itself. The charging device 205 may be plugged in (e.g., receive power) and then perform diagnostics to receive diagnostic in response to receiving power. In some examples, the charging device 205 may receive a request from the wearable device 210 to perform diagnostics once the inductive link is established. In some cases, the charging device 205 may perform the diagnostic tests (e.g., procedures) at the time of charger device-boot regardless of whether the wearable device 210 is coupled with the charging device 205. The charger device-boot may be an example of the charging device 205 powering on. In such cases, the charging device 205 may perform the diagnostics after the charging device 205 is powered on.

The charging device may store the diagnostic data in an internal memory storage component and wait to send the diagnostic data until the wearable device 210 requests the diagnostic data. For example, the charging device 205 may perform the diagnostics tests and store the diagnostic data until the charging device 205 is powered off. The charging device 205 sends the stored diagnostics data to the wearable device 210 when the wearable device 210 is coupled with the charging device 205, as described herein.

At 220, the charging device 205 may detect that the wearable device 210 is coupled to the charging device 205. In some cases, the charging device 205 may detect that the wearable device 210 is mounted to the charging device 205 based on a load detection procedure. That is, the charging device 205 may detect a change in an inductive load due to a coupling between the inductive charging components of the charging device 205 and the wearable device 210.

At 225, the wearable device 210 may activate communication circuitry. For example, the wearable device 210 may activate charging-based communication circuitry in response to the wearable device 210 being coupled to a charging device 205. The communication circuitry may include one or more inductive charging components (e.g., inductive charging components 125-a). In such cases, an inductive charging link between the charging device 205 and the wearable device 210 may be formed using the one or more inductive charging components. In particular, the inductive charging link may be formed based on the inductive charging component 125-a of the wearable device 210 being placed within a threshold proximity/distance of the inductive charging components 125-b of the charging device 205.

At 230, the charging device 205 may transmit power to charge the wearable device 210. For example, the charging device 205 may output power to charge the wearable device 210 during a charging session for the wearable device 210. The charging device 205 may output the power via the inductive charging link between the charging device 205 and the wearable device 210. In some cases, the charging device 205 may output the power based on (e.g., after) detecting that the wearable device 210 is coupled to the charging device 205. The wearable device 210 may receive the power from the charging device 205 via the charging-based communication circuitry during the charging session.

At 235, the wearable device 210 may recharge the battery of the wearable device 210 using the power received via the inductive charging link. In such cases, the wearable device 210 may start to recharge the battery after receiving the power from the charging device 205.

At 240, the wearable device 210 may transmit a request. The request may be an example of a request for charger diagnostic data. For example, the wearable device 210 may output, to the charging device 205 and via the inductive charging link, the request for the charger diagnostic data in response to receiving the power from the charging device 205. The charging device 205 may receive the request from the wearable device 210 for the charger diagnostic data.

At 245, the charging device 205 may transmit the charger diagnostic data. For example, the charging device 205 may output, via the inductive charging link as part of the charging session, charger diagnostic data associated with one or more inductive charging components of the charging device. The wearable device 210 may receive, via the inductive charging link as part of the charging session, the charger diagnostic data.

The charger diagnostic data may include a firmware version of the charging device 205, a serial number of the charging device 205 that may enable manufacturing information tracking, a size of the charging device 205, a manufacturer of the charging device 205, a hardware version of the charging device 205, statistics on the efficiency or performance of charging sessions/procedures from the perspective of the charging device 205 (e.g., timing of charging sessions/procedures, duration of charging sessions/procedures, error counts, observed inductive loads, etc.), and the like. In some cases, the manufacturer of the charging device 205 and the hardware version of the charging device 205 may be derived from the serial number of the charging device 205.

The charger diagnostic data may also include an input voltage of the charging device 205 (e.g., voltage of a power source/electrical socket that powers the charging device 205), a supply voltage associated with the one or more inductive charging components (e.g., supply voltage applied to the inductive charging components 125-b), information associated with an internal pin check, or any combination thereof. The input voltage may be an example of USB-voltage measurement results that indicate a voltage supplied to the charging device 205 from a charging outlet. The information associated with an internal pin check may be an example of communication channel self-test results that test the hardware capability to determine whether the internal pins of the charging device 205 are working correctly so the inductive link can be established between the charging device 205 and the wearable device 210.

In some cases, the charger diagnostic data may include charger interface self-tests results that indicate whether the charging device 205 is not performing properly (or not performing at all) and may be used to notify the user that a replacement charging device 205 may be recommended in the future. The charger diagnostic data may include overvoltage charging prevention results that indicate whether a voltage applied to charging device 205, to the wearable device 210, or both may overheat, and in some cases, may indicate that the user is using an improper supply. The charger diagnostic data may include LED self-test results that tests the LED system 150 to indicate a charging status. In some cases, the charger diagnostic data may include charger temperature protection result, environmental monitoring, or both.

In other cases, the charging device 205 may transmit other types of data in addition to, or in the alternate to, the charger diagnostic data. For example, the charging device 205 may transmit data acquired via sensors at the charging device 205, such as the temperature sensors 135, humidity sensors 140, noise sensors 145, and the like, as well as other performance information associated with various sensors of the charging device 205.

The charger diagnostic data may be used to determine if the user of the wearable device 210 is using a charging device 205 that is not compatible with the wearable device 210 (e.g., a wrong size, a wrong manufacturer, and the like). The charger diagnostic data may be used to track charger performance features and troubleshoot issues via the inductive communication link between the charging device 205 and the wearable device 210, thereby leading to more effective charging for the wearable device 210 (e.g., faster charging, more efficient/optimized charge signal, reduced or eliminated charging errors, and the like). Moreover, techniques described herein may enable firmware updates for the charger to be communicated to the charger via the inductive communication link. That is, aspects of the present disclosure may utilize the inductive charging link between the charger and the wearable device to exchange charger diagnostic data, firmware updates, etc. As such, by inductively communicating data between the charging device 205 and the wearable device 210 via the inductive charging link, issues with the charging device 205 may be identified, and the charging device 205 may be remotely updated without having to replace the charging device 205 itself, thereby increasing the overall user experience.

The charger diagnostic data is outputted after performing the one or more diagnostic procedures. In some cases, the charger diagnostic data is output in response to the request for the charger diagnostic data. In other examples, the charger diagnostic data is output regardless of whether a request is received at the charging device 205.

The wearable device 210 may include instructions embedded in the internal logic of the wearable device 210 to retrieve charger diagnostic data while charging. The wearable device 210 may request and/or receive the charger diagnostic data every time the wearable device 210 is coupled to the charging device 205. In some cases, the wearable device 210 may store the charger diagnostic data and timestamp the charger diagnostic data to indicate a time that the charger diagnostic data is received at the wearable device, a time that the charger diagnostic data is retrieved from the charging device 205, or both. In some cases, the wearable device 210 may overwrite the previously received charger diagnostic data. In other examples, the wearable device 210 may store the newly received charger diagnostic data in addition to the previously received charger diagnostic data.

In some implementations, the wearable device 210 may be configured to process the charger diagnostic data, and/or relay the charger diagnostic data to the user device 106 and/or servers 110 for processing. In this regard, the wearable device 210 may relay the charger diagnostic data to the servers 110 so that customer service personnel are able to access the charger diagnostic data and identify issues with the charger (e.g., to provide instructions to the user to address the issue, send a replacement charger, implement a firmware update, etc.).

At 250, the charging device 205 may transmit additional power. For example, the charging device 205 may output, to the wearable device 210 via the inductive charging link as part of the charging session, additional power to charge the wearable device 210 during the charging session. In such cases, the wearable device 210 may receive, via the inductive charging link as part of the charging session, the additional power after receiving the charger diagnostic data.

At 255, additional messages may be transmitted between the charging device 205 and the wearable device 210. For example, the wearable device 210 may output, via the inductive charging link, one or more messages associated with a firmware update for the charging device 205 based on receiving the charger diagnostic data. That is, the charger diagnostic data may be used to identify issues with the charging device 205, and the inductive charging link may be used to communicate a firmware update back to the charging device 205 to address the issues. In such cases, the charging device 205 may receive, via the inductive charging link, the one or more messages associated with the firmware update for the charging device. The charging device 205 may implement the firmware update at the charging device 205 using one or more processors of the charging device 205.

In such cases, the charging device 205 uses the inductive charging interface to receive over-the-air updates (e.g., firmware updates). The messages transmitted from the wearable device 210 to the charging device 205 may be used to implement a firmware update at the charging device 205. For example, the wearable device 210 may send instructions, to the charging device 205, to perform a firmware update. In other examples, the wearable device 210 may transmit a request for the charging device 205 to perform the firmware update. In some cases, the firmware updates may be transmitted prior to receiving the additional power. In such cases, the wearable device 210 may transmit requests and/or messages at a lower power level and prior to receiving additional power, as described with reference to FIG. 3. For example, the charging device 205 may implement the firmware update at or near the end of the charging session (e.g., once the charging is completed and/or near end of charging).

In some cases, the charging device 205 may output, via the inductive charging link, data acquired using one or more sensors of the charging device 205. For example, the charging device 205 may transfer sensed data (e.g., environmental data) to the wearable device 210 where the sensed data may include temperature, moisture, air quality, and/or ambient light collected by the sensors of the charging device 205. The wearable device 210 may receive, from the charging device 205 via the inductive charging link, the one or more messages associated with data acquired using the one or more sensors of the charging device 205. In some cases, the transmission of sensed data may occur before the additional power is sent to the wearable device 210.

The wearable device 210 may relay the charger diagnostic data from the wearable device 210 to an application. For example, the wearable device 210 may receive, via communication circuitry and from an application of a user device, a request for the charger diagnostic data. In response to receiving the request, the wearable device 210 may output, to the application via the communication circuitry, the charger diagnostic data after the charging session is completed. The wearable device 210 may store the charger diagnostic data in an internal memory component. After the application of the user device connects to the wearable device 210, the wearable device 210 may perform an error check prior to transmitting the charger diagnostic data. The wearable device 210 may transmit the charger diagnostic data to the application when the wearable device 210 is coupled with the charging device 205.

By inductively communicating charger diagnostic data via the inductive charging link issues with the charging device may be efficiently diagnosed. The charger diagnostic data may be used to track charger performance features and troubleshooting issues via the inductive communication link between the charger and the wearable device, thereby leading to faster charging, stronger charge signal, and reduced or eliminated charging errors for the wearable device 210. Further, by communicating firmware update information between the charging device 205 and the wearable device 210 via the inductive charging link, the charging device 205 may be remotely updated without having to replace the charging device 205 itself, thereby increasing the overall user experience.

FIG. 3 shows an example of timing diagrams 300-a, 300-b that supports charger diagnostics and updates via a charging interface in accordance with aspects of the present disclosure. The timing diagrams 300-a, 300-b may implement, or be implemented by, aspects of the system 100, the process flow 200, or both.

The wearable device may include inductive charging components and charging-based communication circuitry that may be activated or otherwise implemented to charge and communicate with the charging device while charging. The charging device may include inductive charging components and charging-based communication circuitry that may be employed to charge the wearable device and communicate with the wearable device. Communications may include charging status, charging information, charger diagnostic data, physiological data transfer, environmental data transfer, and other communications (e.g., charging fault or other remedy-related communication between the charging device and the wearable device, or other negotiations) between the devices that may be advantageous.

The charging device and the wearable device may communicate various messages by modulating power output. The charging device may output power and detect when power is drawn by the wearable device. The output power levels may correspond to detected voltage levels at the wearable device. That is, if the charging device outputs more power, the wearable device 305 may detect increased voltage levels. To communicate, the charging device and the wearable device may perform an initial connection procedure, or link establishment procedure. The charging device may detect that the wearable device is present (e.g., by detecting an initial power draw).

Timing diagram 300-a may be an example of a charging session in which power is initially outputted at power level P1 and then increased to power level P2. The charging session may span from time t0 to time t3. As shown in timing diagram 300-a, at time t0, the charging device may output power level P1, and the wearable device may receive the output power level P1 from the charging device. In such cases, the charging device may output power level P1, from time t0 to time t2, to charge the wearable device during the first portion of the charging session for the wearable device. The first portion of the charging session may span a duration of time between time t0 and time t2.

At time t1, the charging device may receive a request to transmit charger diagnostic data, and the charging device may transmit the charger diagnostic data while continuing to output power level P1 to charge the wearable device. In such cases, the charger diagnostic data may be transmitted during the first portion of the charging session. The power level P1 may be an example of a first power level used to charge the wearable device during the first portion of the charging session. The power level P1 may be associated with a first charging rate of the wearable device during the first portion of the charging session. In such cases, the charger diagnostic data may be output during the first portion of the charging session associated with power level P1.

During the first portion of the charging session (e.g., from time t0 to time t2), the wearable device may experience slower charging while the charging device is also communicating the charger diagnostic data and/or other messages. Other messages may be an example of a firmware update, data sensed by one or more sensors of the charging device, and the like. The charging session may begin with lower power level P1 output by the charging device to enable simultaneously transferring the charger diagnostic data during the charging session and then increasing to power level P2 after the charger diagnostic data is transferred. In some examples, the charging device may increase the power from power level P1 to power level P2 at time t2 in response to the completion of sending the charger diagnostic data to the wearable device. In such cases, after the charger diagnostic data is sent, the charging device may increase to power level P2, thereby increasing the charging efficiency.

At time t2, the charging device may output power level P2 to charge the wearable device during a second portion of the charging session for the wearable device, and the wearable device may receive the power level P2 from the charging device. In such cases, the transmission of the charger diagnostic data may be complete, and the wearable device may receive the charger diagnostic data at time t2. The power level P2 may be an example of additional power to charge the wearable device during the second portion of the charging session. The second portion of the charging session may be a duration of time from time t2 to time t3.

The power level P2 may be associated with a second power level used to charge the wearable device during a second portion of the charging session. The power level P2 is greater than the power level P1. In such cases, the charging device maintains the power at lower levels (e.g., power level P1) to charge the wearable device while also sending the charger diagnostic data and then increases to power level P2 to charge the wearable device after the charger diagnostic data is sent.

The power level P2 may be associated with a second charging rate of the wearable device during the second portion of the charging session. In some cases, the second charging rate is greater than the first charging rate. In such cases, the charging rate of the wearable is increased once the charger diagnostic data has been transmitted. In some cases, the power level and the charging rate are the same. That is, the wearable device may charge faster once the charger diagnostic data has been exchanged.

In some cases, messages and/or requests from the wearable device may trigger the change in power levels output by the charging device. For example, at time t2, the wearable device may request additional power to charge the wearable device based on the wearable device receiving the charger diagnostic data. In response to receiving the request, the charging device may output power P2 to continue charging the wearable device at increased speeds and efficiency.

Timing diagram 300-b may be an example of a charging session in which power is initially outputted at power level P2, decreased to power level P1, and then increased to power level P2. The charging session may span from time t0 to time t3. As shown in timing diagram 300-b, at time t0, the charging device may output power level P2, and the wearable device may receive the output power level P2 from the charging device. In such cases, the charging device may output power level P2, from time t0 to time t1, to charge the wearable device during a first portion of the charging session for the wearable device. The first portion of the charging session may span a duration of time between time t0 and time t2.

At time t1, the charging device may receive a request to transmit charger diagnostic data. After the charging device receives the request, the charging device may decrease the power output to power level P1 to continue charging the wearable device at decreased power levels while also communicating the charger diagnostic data. From time t1 to time t2, the charging device may transmit the charger diagnostic data, and the wearable device may experience slower charging while the charging device is also communicating the charger diagnostic data and/or other messages.

That is, at time t1, the charging device may decrease the power output to charge the wearable device by decreasing from power level P2 to power level P1 to enable transferring the charger diagnostic data during the charging session. After the charger diagnostic data is transferred, the charging device may increase the power to power level P2 at time t2. In some examples, the charging device may increase the power from power level P1 to power level P2 at time t2 in response to the completion of sending the charger diagnostic data and/or other messages to the wearable device. In such cases, after the charger diagnostic data is sent, the charging device may increase the power to power level P2, thereby increasing the charging efficiency.

At time t2, the charging device may output power level P2 to continue charging the wearable device during the charging session for the wearable device, and the wearable device may receive the power level P2 from the charging device. In such cases, the transmission of the charger diagnostic data may be complete, and the wearable device may have received the charger diagnostic data at time t2. In such cases, the charging rate of the wearable is increased once the charger diagnostic data has been transmitted. That is, the wearable device may charge faster once the charger diagnostic data has been exchanged.

In some cases, messages and/or requests from the wearable device may trigger the change in power levels output by the charging device. For example, at time t1, the wearable device may request the charger diagnostic data, and in response to receiving the request, the charging device may decrease the charging power from power level P2 to power level P1 and transmit the charger diagnostic data. In such cases, the reduction of power level (e.g., at the start of the charging session or after the charging session has commenced) may be triggered based on a request from the wearable device for the charger diagnostic data. At time t2, the wearable device may request additional power to charge the wearable device based on the wearable device receiving the charger diagnostic data. In response to receiving the request, the charging device may output power level P2 to continue charging the wearable device at increased speeds and efficiency. In other examples, at time t1, the wearable device may send a command to the charging device, and in response to receiving the command, the charging device may decrease the charging power from power level P2 to power level P1 and transmit non-diagnostic data. In such cases, the charging device may refrain from transmitting charger diagnostic data in response to receiving the command.

In additional or alternative cases, the charging power (e.g., power level) used to charge the wearable device during communication of the charger diagnostic data may be greater than the charging power (e.g., power level) used to charge the wearable device after the charger diagnostic data has been communicated. That is, in some cases, the second power level (e.g., power level after the charger diagnostic data has been transmitted) may be less than the first power level (e.g., power level used while the charger diagnostic data is being transmitted). This situation may occur when the battery of the wearable device is full, or nearly full (e.g., battery level above some threshold). For example, during the connection establishment between the wearable device and the charger device, there may be a static load (e.g., static communication/inductive load) on the wearable device side. In such cases, when the battery at the wearable device is full (or nearly full), there may be no additional power consumption on the wearable device side, and the charging power (e.g., power level) transferred to the wearable device may be reduced or terminated. For instance, referring to the first timing diagram 300-a, in cases where the battery of the wearable device becomes full (or nearly full) between t1 and t2 (e.g., while the charger diagnostic data is communicated), the charging power/power level may be decreased after t2, such that the second power level after t2 is less than the first power level prior to t2.

In some cases, the wearable device may request a predetermined amount of power to charge the wearable device and/or a duration of time to receive power output by the charging device. In such cases, the charging device may output the predetermined amount of power to charge the wearable device, output power for the duration of time, or both to effectively charge the wearable device.

The charging session may be optimized by not having to pause the charging session while communicating the charger diagnostic data. In some cases, the overall overhead of the system may be decreased by charging the wearable device at decreased power levels P1 while also transmitting charger diagnostic data, thereby preventing overheating of the wearable ring device, the charging device, or both and reducing or eliminating charging errors for the wearable device.

In some examples, the wearable device may transmit, to the charging device, a request to pause the charging session in order to perform actions that may be inhibited during the charging session. For example, the wearable device may transmit a request to the charging device to fully disable the charging session for a predetermined duration of time. The charging device may pause the charging session and/or fully disable (e.g., end) the charging session and perform a self-diagnostic procedure while the charging session is paused or disabled.

The sequences described in timing diagram 300-a and timing diagram 300-b are not limited to the examples described herein, but may occur multiple times and/or in various orders during the charging session.

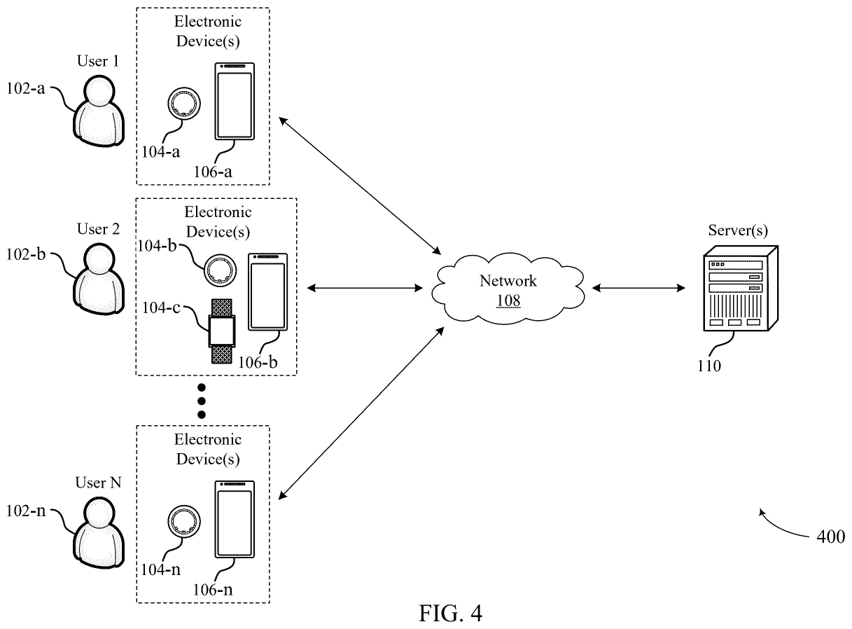

FIG. 4 illustrates an example of a system 400 that supports charger diagnostics and updates via a charging interface in accordance with aspects of the present disclosure. The system 400 includes a plurality of electronic devices (e.g., wearable devices 104, user devices 106) that may be worn and/or operated by one or more users 102, as described herein. The system 400 further includes a network 108 and one or more servers 110.

The electronic devices may include any electronic devices known in the art, including wearable devices 104 (e.g., ring wearable devices, watch wearable devices, etc.), user devices 106 (e.g., smartphones, laptops, tablets). The electronic devices associated with the respective users 102 may include one or more of the following functionalities: 1) measuring physiological data, 2) storing the measured data, 3) processing the data, 4) providing outputs (e.g., via GUIs) to a user 102 based on the processed data, and 5) communicating data with one another and/or other computing devices. Different electronic devices may perform one or more of the functionalities.

Example wearable devices 104 may include wearable computing devices, such as a ring computing device (hereinafter “ring”) configured to be worn on a user's 102 finger, a wrist computing device (e.g., a smart watch, fitness band, or bracelet) configured to be worn on a user's 102 wrist, and/or a head mounted computing device (e.g., glasses/goggles). Wearable devices 104 may also include bands, straps (e.g., flexible or inflexible bands or straps), stick-on sensors, and the like, that may be positioned in other locations, such as bands around the head (e.g., a forehead headband), arm (e.g., a forearm band and/or bicep band), and/or leg (e.g., a thigh or calf band), behind the ear, under the armpit, and the like. Wearable devices 104 may also be attached to, or included in, articles of clothing. For example, wearable devices 104 may be included in pockets and/or pouches on clothing. As another example, wearable device 104 may be clipped and/or pinned to clothing, or may otherwise be maintained within the vicinity of the user 102. Example articles of clothing may include, but are not limited to, hats, shirts, gloves, pants, socks, outerwear (e.g., jackets), and undergarments. In some implementations, wearable devices 104 may be included with other types of devices such as training/sporting devices that are used during physical activity. For example, wearable devices 104 may be attached to, or included in, a bicycle, skis, a tennis racket, a golf club, and/or training weights.

Much of the present disclosure may be described in the context of a ring wearable device 104. Accordingly, the terms “ring 104,” “wearable device 104,” and like terms, may be used interchangeably, unless noted otherwise herein. However, the use of the term “ring 104” is not to be regarded as limiting, as it is contemplated herein that aspects of the present disclosure may be performed using other wearable devices (e.g., watch wearable devices, necklace wearable device, bracelet wearable devices, earring wearable devices, anklet wearable devices, and the like).

In some aspects, user devices 106 may include handheld mobile computing devices, such as smartphones and tablet computing devices. User devices 106 may also include personal computers, such as laptop and desktop computing devices. Other example user devices 106 may include server computing devices that may communicate with other electronic devices (e.g., via the Internet). In some implementations, computing devices may include medical devices, such as external wearable computing devices (e.g., Holter monitors). Medical devices may also include implantable medical devices, such as pacemakers and cardioverter defibrillators. Other example user devices 106 may include home computing devices, such as internet of things (IoT) devices (e.g., IoT devices), smart televisions, smart speakers, smart displays (e.g., video call displays), hubs (e.g., wireless communication hubs), security systems, smart appliances (e.g., thermostats and refrigerators), and fitness equipment.

Some electronic devices (e.g., wearable devices 104, user devices 106) may measure physiological parameters of respective users 102, such as photoplethysmography waveforms, continuous skin temperature, a pulse waveform, respiration rate, heart rate, heart rate variability (HRV), actigraphy, galvanic skin response, pulse oximetry, blood oxygen saturation (SpO2), blood sugar levels (e.g., glucose metrics), and/or other physiological parameters. Some electronic devices that measure physiological parameters may also perform some/all of the calculations described herein. Some electronic devices may not measure physiological parameters, but may perform some/all of the calculations described herein. For example, a ring (e.g., wearable device 104), mobile device application, or a server computing device may process received physiological data that was measured by other devices.

In some implementations, a user 102 may operate, or may be associated with, multiple electronic devices, some of which may measure physiological parameters and some of which may process the measured physiological parameters. In some implementations, a user 102 may have a ring (e.g., wearable device 104) that measures physiological parameters. The user 102 may also have, or be associated with, a user device 106 (e.g., mobile device, smartphone), where the wearable device 104 and the user device 106 are communicatively coupled to one another. In some cases, the user device 106 may receive data from the wearable device 104 and perform some/all of the calculations described herein. In some implementations, the user device 106 may also measure physiological parameters described herein, such as motion/activity parameters.

For example, as illustrated in FIG. 1, a first user 102-a (User 1) may operate, or may be associated with, a wearable device 104-a (e.g., ring 104-a) and a user device 106-a that may operate as described herein. In this example, the user device 106-a associated with user 102-a may process/store physiological parameters measured by the ring 104-a. Comparatively, a second user 102-b (User 2) may be associated with a ring 104-b, a watch wearable device 104-c (e.g., watch 104-c), and a user device 106-b, where the user device 106-b associated with user 102-b may process/store physiological parameters measured by the ring 104-b and/or the watch 104-c. Moreover, an nth user 102-n (User N) may be associated with an arrangement of electronic devices described herein (e.g., ring 104-n, user device 106-n). In some aspects, wearable devices 104 (e.g., rings 104, watches 104) and other electronic devices may be communicatively coupled to the user devices 106 of the respective users 102 via Bluetooth, Wi-Fi, and other wireless protocols. Moreover, in some cases, the wearable device 104 and the user device 106 may be included within (or make up) the same device. For example, in some cases, the wearable device 104 may be configured to execute an application associated with the wearable device 104, and may be configured to display data via a GUI.

In some implementations, the rings 104 (e.g., wearable devices 104) of the system 400 may be configured to collect physiological data from the respective users 102 based on arterial blood flow within the user's finger. In particular, a ring 104 may utilize one or more light-emitting components, such as LEDs (e.g., red LEDs, green LEDs) that emit light on the palm-side of a user's finger to collect physiological data based on arterial blood flow within the user's finger. In general, the terms light-emitting components, light-emitting elements, and like terms, may include, but are not limited to, LEDs, micro LEDs, mini LEDs, laser diodes (LDs) (e.g., vertical cavity surface-emitting lasers (VCSELs), and the like.

In some cases, the system 400 may be configured to collect physiological data from the respective users 102 based on blood flow diffused into a microvascular bed of skin with capillaries and arterioles. For example, the system 400 may collect PPG data based on a measured amount of blood diffused into the microvascular system of capillaries and arterioles. In some implementations, the ring 104 may acquire the physiological data using a combination of both green and red LEDs. The physiological data may include any physiological data known in the art including, but not limited to, temperature data, accelerometer data (e.g., movement/motion data), heart rate data, HRV data, blood oxygen level data, or any combination thereof.

The use of both green and red LEDs may provide several advantages over other solutions, as red and green LEDs have been found to have their own distinct advantages when acquiring physiological data under different conditions (e.g., light/dark, active/inactive) and via different parts of the body, and the like. For example, green LEDs have been found to exhibit better performance during exercise. Moreover, using multiple LEDs (e.g., green and red LEDs) distributed around the ring 104 has been found to exhibit superior performance as compared to wearable devices that utilize LEDs that are positioned close to one another, such as within a watch wearable device. Furthermore, the blood vessels in the finger (e.g., arteries, capillaries) are more accessible via LEDs as compared to blood vessels in the wrist. In particular, arteries in the wrist are positioned on the bottom of the wrist (e.g., palm-side of the wrist), meaning only capillaries are accessible on the top of the wrist (e.g., back of hand side of the wrist), where wearable watch devices and similar devices are typically worn. As such, utilizing LEDs and other sensors within a ring 104 has been found to exhibit superior performance as compared to wearable devices worn on the wrist, as the ring 104 may have greater access to arteries (as compared to capillaries), thereby resulting in stronger signals and more valuable physiological data.

The electronic devices of the system 400 (e.g., user devices 106, wearable devices 104) may be communicatively coupled to one or more servers 110 via wired or wireless communication protocols. For example, as shown in FIG. 1, the electronic devices (e.g., user devices 106) may be communicatively coupled to one or more servers 110 via a network 108. The network 108 may implement transfer control protocol and internet protocol (TCP/IP), such as the Internet, or may implement other network 108 protocols. Network connections between the network 108 and the respective electronic devices may facilitate transport of data via email, web, text messages, mail, or any other appropriate form of interaction within a computer network 108. For example, in some implementations, the ring 104-a associated with the first user 102-a may be communicatively coupled to the user device 106-a, where the user device 106-a is communicatively coupled to the servers 110 via the network 108. In additional or alternative cases, wearable devices 104 (e.g., rings 104, watches 104) may be directly communicatively coupled to the network 108.

The system 400 may offer an on-demand database service between the user devices 106 and the one or more servers 110. In some cases, the servers 110 may receive data from the user devices 106 via the network 108, and may store and analyze the data. Similarly, the servers 110 may provide data to the user devices 106 via the network 108. In some cases, the servers 110 may be located at one or more data centers. The servers 110 may be used for data storage, management, and processing. In some implementations, the servers 110 may provide a web-based interface to the user device 106 via web browsers.

In some aspects, the system 400 may detect periods of time that a user 102 is asleep, and classify periods of time that the user 102 is asleep into one or more sleep stages (e.g., sleep stage classification). For example, as shown in FIG. 1, User 102-a may be associated with a wearable device 104-a (e.g., ring 104-a) and a user device 106-a. In this example, the ring 104-a may collect physiological data associated with the user 102-a, including temperature, heart rate, HRV, respiratory rate, and the like. In some aspects, data collected by the ring 104-a may be input to a machine learning classifier, where the machine learning classifier is configured to determine periods of time that the user 102-a is (or was) asleep. Moreover, the machine learning classifier may be configured to classify periods of time into different sleep stages, including an awake sleep stage, a rapid eye movement (REM) sleep stage, a light sleep stage (non-REM (NREM)), and a deep sleep stage (NREM). In some aspects, the classified sleep stages may be displayed to the user 102-a via a GUI of the user device 106-a. Sleep stage classification may be used to provide feedback to a user 102-a regarding the user's sleeping patterns, such as recommended bedtimes, recommended wake-up times, and the like. Moreover, in some implementations, sleep stage classification techniques described herein may be used to calculate scores for the respective user, such as Sleep Scores, Readiness Scores, and the like.

In some aspects, the system 400 may utilize circadian rhythm-derived features to further improve physiological data collection, data processing procedures, and other techniques described herein. The term circadian rhythm may refer to a natural, internal process that regulates an individual's sleep-wake cycle, that repeats approximately every 24 hours. In this regard, techniques described herein may utilize circadian rhythm adjustment models to improve physiological data collection, analysis, and data processing. For example, a circadian rhythm adjustment model may be input into a machine learning classifier along with physiological data collected from the user 102-a via the wearable device 104-a. In this example, the circadian rhythm adjustment model may be configured to “weight,” or adjust, physiological data collected throughout a user's natural, approximately 24-hour circadian rhythm. In some implementations, the system may initially start with a “baseline” circadian rhythm adjustment model, and may modify the baseline model using physiological data collected from each user 102 to generate tailored, individualized circadian rhythm adjustment models that are specific to each respective user 102.

In some aspects, the system 400 may utilize other biological rhythms to further improve physiological data collection, analysis, and processing by phase of these other rhythms. For example, if a weekly rhythm is detected within an individual's baseline data, then the model may be configured to adjust “weights” of data by day of the week. Biological rhythms that may require adjustment to the model by this method include: 1) ultradian (faster than a day rhythms, including sleep cycles in a sleep state, and oscillations from less than an hour to several hours periodicity in the measured physiological variables during wake state; 2) circadian rhythms; 3) non-endogenous daily rhythms shown to be imposed on top of circadian rhythms, as in work schedules; 4) weekly rhythms, or other artificial time periodicities exogenously imposed (e.g., in a hypothetical culture with 12 day “weeks,” 12 day rhythms could be used); 5) multi-day ovarian rhythms in women and spermatogenesis rhythms in men; 6) lunar rhythms (relevant for individuals living with low or no artificial lights); and 7) seasonal rhythms.

The biological rhythms are not always stationary rhythms. For example, many women experience variability in ovarian cycle length across cycles, and ultradian rhythms are not expected to occur at exactly the same time or periodicity across days even within a user. As such, signal processing techniques sufficient to quantify the frequency composition while preserving temporal resolution of these rhythms in physiological data may be used to improve detection of these rhythms, to assign phase of each rhythm to each moment in time measured, and to thereby modify adjustment models and comparisons of time intervals. The biological rhythm-adjustment models and parameters can be added in linear or non-linear combinations as appropriate to more accurately capture the dynamic physiological baselines of an individual or group of individuals.

In some aspects, the respective devices of the system 400 may support techniques for transmitting charger diagnostic data to the wearable device during the charging session. For example, the charger may determine that the wearable device is drawing power (e.g., charging) and transmit the charger diagnostic data while simultaneously charging the wearable device. In such cases, the charger may start outputting power for a charging session once it detects the wearable device and then start transmitting the charger diagnostic data while outputting the power. The charger may continue to transmit additional power (e.g., at equal to or greater than power levels) to continue the charging session once the charger diagnostic data is transmitted. After the charger diagnostic data is received at the wearable device, the wearable device may store the charger diagnostic data until the wearable device communicates with the application to transfer the charger diagnostic data to the application.

It should be appreciated by a person skilled in the art that one or more aspects of the disclosure may be implemented in a system 400 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 5 illustrates an example of a system 500 that supports charger diagnostics and updates via a charging interface in accordance with aspects of the present disclosure. In particular, system 500 illustrates an example of a ring 104 (e.g., wearable device 104), a user device 106, and a server 110, as described herein.

In some aspects, the ring 104 may be configured to be worn around a user's finger, and may determine one or more user physiological parameters when worn around the user's finger. Example measurements and determinations may include, but are not limited to, user skin temperature, pulse waveforms, respiratory rate, heart rate, HRV, blood oxygen levels (SpO2), blood sugar levels (e.g., glucose metrics), and the like.

The system 500 further includes a user device 106 (e.g., a smartphone) in communication with the ring 104. For example, the ring 104 may be in wireless and/or wired communication with the user device 106. In some implementations, the ring 104 may send measured and processed data (e.g., temperature data, photoplethysmogram (PPG) data, motion/accelerometer data, ring input data, and the like) to the user device 106. The user device 106 may also send data to the ring 104, such as ring 104 firmware/configuration updates. The user device 106 may process data. In some implementations, the user device 106 may transmit data to the server 110 for processing and/or storage.

The ring 104 may include a housing 505 that may include an inner housing 505-a and an outer housing 505-b. In some aspects, the inner housing 505-a, the outer housing 505-b, or both, may include a curved profile/surface. In particular, the housing 505 may exhibit any curved or “circumferential” profile, including a circular profile, an elliptical profile, and the like. Moreover, in some cases, the inner housing 505-a, the outer housing 505-b, or both, may include both curved (e.g., “circumferential”) and flat/planar portions. For the purposes of the present disclosure, the term “circumferential” may be used interchangeably with the term “curved” to refer to circular-shaped, elliptical-shaped, or other curved-shaped profile.

In some aspects, the housing 505 of the ring 104 may store or otherwise include various components of the ring including, but not limited to, device electronics, a power source (e.g., battery 510, and/or capacitor), one or more substrates (e.g., printable circuit boards) that interconnect the device electronics and/or power source, and the like. The device electronics may include device modules (e.g., hardware/software), such as: a processing module 530-a, a memory 515, a communication module 520-a, a power module 525, and the like. The device electronics may also include one or more sensors. Example sensors may include one or more temperature sensors 540, a PPG sensor assembly (e.g., PPG system 535), and one or more motion sensors 545.

The sensors may include associated modules (not illustrated) configured to communicate with the respective components/modules of the ring 104, and generate signals associated with the respective sensors. In some aspects, each of the components/modules of the ring 104 may be communicatively coupled to one another via wired or wireless connections. Moreover, the ring 104 may include additional and/or alternative sensors or other components that are configured to collect physiological data from the user, including light sensors (e.g., LEDs), oximeters, and the like.

The ring 104 shown and described with reference to FIG. 5 is provided solely for illustrative purposes. As such, the ring 104 may include additional or alternative components as those illustrated in FIG. 5 Other rings 104 that provide functionality described herein may be fabricated. For example, rings 104 with fewer components (e.g., sensors) may be fabricated. In a specific example, a ring 104 with a single temperature sensor 540 (or other sensor), a power source, and device electronics configured to read the single temperature sensor 540 (or other sensor) may be fabricated. In another specific example, a temperature sensor 540 (or other sensor) may be attached to a user's finger (e.g., using adhesives, wraps, clamps, spring loaded clamps, etc.). In this case, the sensor may be wired to another computing device, such as a wrist worn computing device that reads the temperature sensor 540 (or other sensor). In other examples, a ring 104 that includes additional sensors and processing functionality may be fabricated.

The housing 505 may include one or more housing 505 components. The housing 505 may include an outer housing 505-b component (e.g., a shell) and an inner housing 505-a component (e.g., a molding). The housing 505 may include additional components (e.g., additional layers) not explicitly illustrated in FIG. 5. For example, in some implementations, the ring 104 may include one or more insulating layers that electrically insulate the device electronics and other conductive materials (e.g., electrical traces) from the outer housing 505-b (e.g., a metal outer housing 505-b). The housing 505 may provide structural support for the device electronics, battery 510, substrate(s), and other components. For example, the housing 505 may protect the device electronics, battery 510, and substrate(s) from mechanical forces, such as pressure and impacts. The housing 505 may also protect the device electronics, battery 510, and substrate(s) from water and/or other chemicals.

The outer housing 505-b may be fabricated from one or more materials. In some implementations, the outer housing 505-b may include a metal, such as titanium, that may provide strength and abrasion resistance at a relatively light weight. The outer housing 505-b may also be fabricated from other materials, such polymers. In some implementations, the outer housing 505-b may be protective as well as decorative.

The inner housing 505-a may be configured to interface with the user's finger. The inner housing 505-a may be formed from a polymer (e.g., a medical grade polymer) or other material. In some implementations, the inner housing 505-a may be transparent. For example, the inner housing 505-a may be transparent to light emitted by the PPG light emitting diodes (LEDs). In some implementations, the inner housing 505-a component may be molded onto the outer housing 505-b. For example, the inner housing 505-a may include a polymer that is molded (e.g., injection molded) to fit into an outer housing 505-b metallic shell.

The ring 104 may include one or more substrates (not illustrated). The device electronics and battery 510 may be included on the one or more substrates. For example, the device electronics and battery 510 may be mounted on one or more substrates. Example substrates may include one or more printed circuit boards (PCBs), such as flexible PCB (e.g., polyimide). In some implementations, the electronics/battery 510 may include surface mounted devices (e.g., surface-mount technology (SMT) devices) on a flexible PCB. In some implementations, the one or more substrates (e.g., one or more flexible PCBs) may include electrical traces that provide electrical communication between device electronics. The electrical traces may also connect the battery 510 to the device electronics.

The device electronics, battery 510, and substrates may be arranged in the ring 104 in a variety of ways. In some implementations, one substrate that includes device electronics may be mounted along the bottom of the ring 104 (e.g., the bottom half), such that the sensors (e.g., PPG system 535, temperature sensors 540, motion sensors 545, and other sensors) interface with the underside of the user's finger. In these implementations, the battery 510 may be included along the top portion of the ring 104 (e.g., on another substrate).

The various components/modules of the ring 104 represent functionality (e.g., circuits and other components) that may be included in the ring 104. Modules may include any discrete and/or integrated electronic circuit components that implement analog and/or digital circuits capable of producing the functions attributed to the modules herein. For example, the modules may include analog circuits (e.g., amplification circuits, filtering circuits, analog/digital conversion circuits, and/or other signal conditioning circuits). The modules may also include digital circuits (e.g., combinational or sequential logic circuits, memory circuits etc.).

The memory 515 (memory module) of the ring 104 may include any volatile, non-volatile, magnetic, or electrical media, such as a random access memory (RAM), read-only memory (ROM), non-volatile RAM (NVRAM), electrically-erasable programmable ROM (EEPROM), flash memory, or any other memory device. The memory 515 may store any of the data described herein. For example, the memory 515 may be configured to store data (e.g., motion data, temperature data, PPG data) collected by the respective sensors and PPG system 535. Furthermore, memory 515 may include instructions that, when executed by one or more processing circuits, cause the modules to perform various functions attributed to the modules herein. The device electronics of the ring 104 described herein are only example device electronics. As such, the types of electronic components used to implement the device electronics may vary based on design considerations.

The functions attributed to the modules of the ring 104 described herein may be embodied as one or more processors, hardware, firmware, software, or any combination thereof. Depiction of different features as modules is intended to highlight different functional aspects and does not necessarily imply that such modules must be realized by separate hardware/software components. Rather, functionality associated with one or more modules may be performed by separate hardware/software components or integrated within common hardware/software components.

The processing module 530-a of the ring 104 may include one or more processors (e.g., processing units), microcontrollers, digital signal processors, systems on a chip (SOCs), and/or other processing devices. The processing module 530-a communicates with the modules included in the ring 104. For example, the processing module 530-a may transmit/receive data to/from the modules and other components of the ring 104, such as the sensors. As described herein, the modules may be implemented by various circuit components. Accordingly, the modules may also be referred to as circuits (e.g., a communication circuit and power circuit).

The processing module 530-a may communicate with the memory 515. The memory 515 may include computer-readable instructions that, when executed by the processing module 530-a, cause the processing module 530-a to perform the various functions attributed to the processing module 530-a herein. In some implementations, the processing module 530-a (e.g., a microcontroller) may include additional features associated with other modules, such as communication functionality provided by the communication module 520-a (e.g., an integrated Bluetooth Low Energy transceiver) and/or additional onboard memory 515.

The communication module 520-a may include circuits that provide wireless and/or wired communication with the user device 106 (e.g., communication module 520-b of the user device 106). In some implementations, the communication modules 520-a, 520-b may include wireless communication circuits, such as Bluetooth circuits and/or Wi-Fi circuits. In some implementations, the communication modules 520-a, 520-b can include wired communication circuits, such as Universal Serial Bus (USB) communication circuits. Using the communication module 520-a, the ring 104 and the user device 106 may be configured to communicate with each other. The processing module 530-a of the ring may be configured to transmit/receive data to/from the user device 106 via the communication module 520-a. Example data may include, but is not limited to, motion data, temperature data, pulse waveforms, heart rate data, HRV data, PPG data, and status updates (e.g., charging status, battery charge level, and/or ring 104 configuration settings). The processing module 530-a of the ring may also be configured to receive updates (e.g., software/firmware updates) and data from the user device 106.

The ring 104 may include a battery 510 (e.g., a rechargeable battery 510). An example battery 510 may include a Lithium-Ion or Lithium-Polymer type battery 510, although a variety of battery 510 options are possible. The battery 510 may be wirelessly charged. In some implementations, the ring 104 may include a power source other than the battery 510, such as a capacitor. The power source (e.g., battery 510 or capacitor) may have a curved geometry that matches the curve of the ring 104. In some aspects, a charger or other power source may include additional sensors that may be used to collect data in addition to, or that supplements, data collected by the ring 104 itself. Moreover, a charger or other power source for the ring 104 may function as a user device 106, in which case the charger or other power source for the ring 104 may be configured to receive data from the ring 104, store and/or process data received from the ring 104, and communicate data between the ring 104 and the servers 110.

In some aspects, the ring 104 includes a power module 525 that may control charging of the battery 510. For example, the power module 525 may interface with an external wireless charger that charges the battery 510 when interfaced with the ring 104. The charger may include a datum structure that mates with a ring 104 datum structure to create a specified orientation with the ring 104 during charging. The power module 525 may also regulate voltage(s) of the device electronics, regulate power output to the device electronics, and monitor the state of charge of the battery 510. In some implementations, the battery 510 may include a protection circuit module (PCM) that protects the battery 510 from high current discharge, over voltage during charging, and under voltage during discharge. The power module 525 may also include electro-static discharge (ESD) protection.

The one or more temperature sensors 540 may be electrically coupled to the processing module 530-a. The temperature sensor 540 may be configured to generate a temperature signal (e.g., temperature data) that indicates a temperature read or sensed by the temperature sensor 540. The processing module 530-a may determine a temperature of the user in the location of the temperature sensor 540. For example, in the ring 104, temperature data generated by the temperature sensor 540 may indicate a temperature of a user at the user's finger (e.g., skin temperature). In some implementations, the temperature sensor 540 may contact the user's skin. In other implementations, a portion of the housing 505 (e.g., the inner housing 505-a) may form a barrier (e.g., a thin, thermally conductive barrier) between the temperature sensor 540 and the user's skin. In some implementations, portions of the ring 104 configured to contact the user's finger may have thermally conductive portions and thermally insulative portions. The thermally conductive portions may conduct heat from the user's finger to the temperature sensors 540. The thermally insulative portions may insulate portions of the ring 104 (e.g., the temperature sensor 540) from ambient temperature.

In some implementations, the temperature sensor 540 may generate a digital signal (e.g., temperature data) that the processing module 530-a may use to determine the temperature. As another example, in cases where the temperature sensor 540 includes a passive sensor, the processing module 530-a (or a temperature sensor 540 module) may measure a current/voltage generated by the temperature sensor 540 and determine the temperature based on the measured current/voltage. Example temperature sensors 540 may include a thermistor, such as a negative temperature coefficient (NTC) thermistor, or other types of sensors including resistors, transistors, diodes, and/or other electrical/electronic components.

The processing module 530-a may sample the user's temperature over time. For example, the processing module 530-a may sample the user's temperature according to a sampling rate. An example sampling rate may include one sample per second, although the processing module 530-a may be configured to sample the temperature signal at other sampling rates that are higher or lower than one sample per second. In some implementations, the processing module 530-a may sample the user's temperature continuously throughout the day and night. Sampling at a sufficient rate (e.g., one sample per second) throughout the day may provide sufficient temperature data for analysis described herein.

The processing module 530-a may store the sampled temperature data in memory 515. In some implementations, the processing module 530-a may process the sampled temperature data. For example, the processing module 530-a may determine average temperature values over a period of time. In one example, the processing module 530-a may determine an average temperature value each minute by summing all temperature values collected over the minute and dividing by the number of samples over the minute. In a specific example where the temperature is sampled at one sample per second, the average temperature may be a sum of all sampled temperatures for one minute divided by sixty seconds. The memory 515 may store the average temperature values over time. In some implementations, the memory 515 may store average temperatures (e.g., one per minute) instead of sampled temperatures in order to conserve memory 515.

The sampling rate, which may be stored in memory 515, may be configurable. In some implementations, the sampling rate may be the same throughout the day and night. In other implementations, the sampling rate may be changed throughout the day/night. In some implementations, the ring 104 may filter/reject temperature readings, such as large spikes in temperature that are not indicative of physiological changes (e.g., a temperature spike from a hot shower). In some implementations, the ring 104 may filter/reject temperature readings that may not be reliable due to other factors, such as excessive motion during exercise (e.g., as indicated by a motion sensor 545).

The ring 104 (e.g., communication module) may transmit the sampled and/or average temperature data to the user device 106 for storage and/or further processing. The user device 106 may transfer the sampled and/or average temperature data to the server 110 for storage and/or further processing.

Although the ring 104 is illustrated as including a single temperature sensor 540, the ring 104 may include multiple temperature sensors 540 in one or more locations, such as arranged along the inner housing 505-a near the user's finger. In some implementations, the temperature sensors 540 may be stand-alone temperature sensors 540. Additionally, or alternatively, one or more temperature sensors 540 may be included with other components (e.g., packaged with other components), such as with the accelerometer and/or processor.

The processing module 530-a may acquire and process data from multiple temperature sensors 540 in a similar manner described with respect to a single temperature sensor 540. For example, the processing module 530 may individually sample, average, and store temperature data from each of the multiple temperature sensors 540. In other examples, the processing module 530-a may sample the sensors at different rates and average/store different values for the different sensors. In some implementations, the processing module 530-a may be configured to determine a single temperature based on the average of two or more temperatures determined by two or more temperature sensors 540 in different locations on the finger.

The temperature sensors 540 on the ring 104 may acquire distal temperatures at the user's finger (e.g., any finger). For example, one or more temperature sensors 540 on the ring 104 may acquire a user's temperature from the underside of a finger or at a different location on the finger. In some implementations, the ring 104 may continuously acquire distal temperature (e.g., at a sampling rate). Although distal temperature measured by a ring 104 at the finger is described herein, other devices may measure temperature at the same/different locations. In some cases, the distal temperature measured at a user's finger may differ from the temperature measured at a user's wrist or other external body location. Additionally, the distal temperature measured at a user's finger (e.g., a “shell” temperature) may differ from the user's core temperature. As such, the ring 104 may provide a useful temperature signal that may not be acquired at other internal/external locations of the body. In some cases, continuous temperature measurement at the finger may capture temperature fluctuations (e.g., small or large fluctuations) that may not be evident in core temperature. For example, continuous temperature measurement at the finger may capture minute-to-minute or hour-to-hour temperature fluctuations that provide additional insight that may not be provided by other temperature measurements elsewhere in the body.

The ring 104 may include a PPG system 535. The PPG system 535 may include one or more optical transmitters that transmit light. The PPG system 535 may also include one or more optical receivers that receive light transmitted by the one or more optical transmitters. An optical receiver may generate a signal (hereinafter “PPG” signal) that indicates an amount of light received by the optical receiver. The optical transmitters may illuminate a region of the user's finger. The PPG signal generated by the PPG system 535 may indicate the perfusion of blood in the illuminated region. For example, the PPG signal may indicate blood volume changes in the illuminated region caused by a user's pulse pressure. The processing module 530-a may sample the PPG signal and determine a user's pulse waveform based on the PPG signal. The processing module 530-a may determine a variety of physiological parameters based on the user's pulse waveform, such as a user's respiratory rate, heart rate, HRV, oxygen saturation, and other circulatory parameters.

In some implementations, the PPG system 535 may be configured as a reflective PPG system 535 where the optical receiver(s) receive transmitted light that is reflected through the region of the user's finger. In some implementations, the PPG system 535 may be configured as a transmissive PPG system 535 where the optical transmitter(s) and optical receiver(s) are arranged opposite to one another, such that light is transmitted directly through a portion of the user's finger to the optical receiver(s).

The number and ratio of transmitters and receivers included in the PPG system 535 may vary. Example optical transmitters may include light-emitting diodes (LEDs). The optical transmitters may transmit light in the infrared spectrum and/or other spectrums. Example optical receivers may include, but are not limited to, photosensors, phototransistors, and photodiodes. The optical receivers may be configured to generate PPG signals in response to the wavelengths received from the optical transmitters. The location of the transmitters and receivers may vary. Additionally, a single device may include reflective and/or transmissive PPG systems 535.

The PPG system 535 illustrated in FIG. 5 may include a reflective PPG system 535 in some implementations. In these implementations, the PPG system 535 may include a centrally located optical receiver (e.g., at the bottom of the ring 104) and two optical transmitters located on each side of the optical receiver. In this implementation, the PPG system 535 (e.g., optical receiver) may generate the PPG signal based on light received from one or both of the optical transmitters. In other implementations, other placements, combinations, and/or configurations of one or more optical transmitters and/or optical receivers are contemplated.

The processing module 530-a may control one or both of the optical transmitters to transmit light while sampling the PPG signal generated by the optical receiver. In some implementations, the processing module 530-a may cause the optical transmitter with the stronger received signal to transmit light while sampling the PPG signal generated by the optical receiver. For example, the selected optical transmitter may continuously emit light while the PPG signal is sampled at a sampling rate (e.g., 550 Hz).

Sampling the PPG signal generated by the PPG system 535 may result in a pulse waveform that may be referred to as a “PPG.” The pulse waveform may indicate blood pressure vs time for multiple cardiac cycles. The pulse waveform may include peaks that indicate cardiac cycles. Additionally, the pulse waveform may include respiratory induced variations that may be used to determine respiration rate. The processing module 530-a may store the pulse waveform in memory 515 in some implementations. The processing module 530-a may process the pulse waveform as it is generated and/or from memory 515 to determine user physiological parameters described herein.

The processing module 530-a may determine the user's heart rate based on the pulse waveform. For example, the processing module 530-a may determine heart rate (e.g., in beats per minute) based on the time between peaks in the pulse waveform. The time between peaks may be referred to as an interbeat interval (IBI). The processing module 530-a may store the determined heart rate values and IBI values in memory 515.

The processing module 530-a may determine HRV over time. For example, the processing module 530-a may determine HRV based on the variation in the IBIs. The processing module 530-a may store the HRV values over time in the memory 515. Moreover, the processing module 530-a may determine the user's respiratory rate over time. For example, the processing module 530-a may determine respiratory rate based on frequency modulation, amplitude modulation, or baseline modulation of the user's IBI values over a period of time. Respiratory rate may be calculated in breaths per minute or as another breathing rate (e.g., breaths per 30 seconds). The processing module 530-a may store user respiratory rate values over time in the memory 515.

The ring 104 may include one or more motion sensors 545, such as one or more accelerometers (e.g., 6-D accelerometers) and/or one or more gyroscopes (gyros). The motion sensors 545 may generate motion signals that indicate motion of the sensors. For example, the ring 104 may include one or more accelerometers that generate acceleration signals that indicate acceleration of the accelerometers. As another example, the ring 104 may include one or more gyro sensors that generate gyro signals that indicate angular motion (e.g., angular velocity) and/or changes in orientation. The motion sensors 545 may be included in one or more sensor packages. An example accelerometer/gyro sensor is a Bosch BMl160 inertial micro electro-mechanical system (MEMS) sensor that may measure angular rates and accelerations in three perpendicular axes.

The processing module 530-a may sample the motion signals at a sampling rate (e.g., 50 Hz) and determine the motion of the ring 104 based on the sampled motion signals. For example, the processing module 530-a may sample acceleration signals to determine acceleration of the ring 104. As another example, the processing module 530-a may sample a gyro signal to determine angular motion. In some implementations, the processing module 530-a may store motion data in memory 515. Motion data may include sampled motion data as well as motion data that is calculated based on the sampled motion signals (e.g., acceleration and angular values).

The ring 104 may store a variety of data described herein. For example, the ring 104 may store temperature data, such as raw sampled temperature data and calculated temperature data (e.g., average temperatures). As another example, the ring 104 may store PPG signal data, such as pulse waveforms and data calculated based on the pulse waveforms (e.g., heart rate values, IBI values, HRV values, and respiratory rate values). The ring 104 may also store motion data, such as sampled motion data that indicates linear and angular motion.

The ring 104, or other computing device, may calculate and store additional values based on the sampled/calculated physiological data. For example, the processing module 530 may calculate and store various metrics, such as sleep metrics (e.g., a Sleep Score), activity metrics, and readiness metrics. In some implementations, additional values/metrics may be referred to as “derived values.” The ring 104, or other computing/wearable device, may calculate a variety of values/metrics with respect to motion. Example derived values for motion data may include, but are not limited to, motion count values, regularity values, intensity values, metabolic equivalence of task values (METs), and orientation values. Motion counts, regularity values, intensity values, and METs may indicate an amount of user motion (e.g., velocity/acceleration) over time. Orientation values may indicate how the ring 104 is oriented on the user's finger and if the ring 104 is worn on the left hand or right hand.

In some implementations, motion counts and regularity values may be determined by counting a number of acceleration peaks within one or more periods of time (e.g., one or more 30 second to 1 minute periods). Intensity values may indicate a number of movements and the associated intensity (e.g., acceleration values) of the movements. The intensity values may be categorized as low, medium, and high, depending on associated threshold acceleration values. METs may be determined based on the intensity of movements during a period of time (e.g., 30 seconds), the regularity/irregularity of the movements, and the number of movements associated with the different intensities.

In some implementations, the processing module 530-a may compress the data stored in memory 515. For example, the processing module 530-a may delete sampled data after making calculations based on the sampled data. As another example, the processing module 530-a may average data over longer periods of time in order to reduce the number of stored values. In a specific example, if average temperatures for a user over one minute are stored in memory 515, the processing module 530-a may calculate average temperatures over a five minute time period for storage, and then subsequently erase the one minute average temperature data. The processing module 530-a may compress data based on a variety of factors, such as the total amount of used/available memory 515 and/or an elapsed time since the ring 104 last transmitted the data to the user device 106.

Although a user's physiological parameters may be measured by sensors included on a ring 104, other devices may measure a user's physiological parameters. For example, although a user's temperature may be measured by a temperature sensor 540 included in a ring 104, other devices may measure a user's temperature. In some examples, other wearable devices (e.g., wrist devices) may include sensors that measure user physiological parameters. Additionally, medical devices, such as external medical devices (e.g., wearable medical devices) and/or implantable medical devices, may measure a user's physiological parameters. One or more sensors on any type of computing device may be used to implement the techniques described herein.

The physiological measurements may be taken continuously throughout the day and/or night. In some implementations, the physiological measurements may be taken during portions of the day and/or portions of the night. In some implementations, the physiological measurements may be taken in response to determining that the user is in a specific state, such as an active state, resting state, and/or a sleeping state. For example, the ring 104 can make physiological measurements in a resting/sleep state in order to acquire cleaner physiological signals. In one example, the ring 104 or other device/system may detect when a user is resting and/or sleeping and acquire physiological parameters (e.g., temperature) for that detected state. The devices/systems may use the resting/sleep physiological data and/or other data when the user is in other states in order to implement the techniques of the present disclosure.

In some implementations, as described previously herein, the ring 104 may be configured to collect, store, and/or process data, and may transfer any of the data described herein to the user device 106 for storage and/or processing. In some aspects, the user device 106 includes a wearable application 550, an operating system (OS), a web browser application (e.g., web browser 580), one or more additional applications, and a GUI 575. The user device 106 may further include other modules and components, including sensors, audio devices, haptic feedback devices, and the like. The wearable application 550 may include an example of an application (e.g., “app”) that may be installed on the user device 106. The wearable application 550 may be configured to acquire data from the ring 104, store the acquired data, and process the acquired data as described herein. For example, the wearable application 550 may include a user interface (UI) module 555, an acquisition module 560, a processing module 530-b, a communication module 520-b, and a storage module (e.g., database 565) configured to store application data.

In some cases, the wearable device 104 and the user device 106 may be included within (or make up) the same device. For example, in some cases, the wearable device 104 may be configured to execute the wearable application 550, and may be configured to display data via the GUI 575.

The various data processing operations described herein may be performed by the ring 104, the user device 106, the servers 110, or any combination thereof. For example, in some cases, data collected by the ring 104 may be pre-processed and transmitted to the user device 106. In this example, the user device 106 may perform some data processing operations on the received data, may transmit the data to the servers 110 for data processing, or both. For instance, in some cases, the user device 106 may perform processing operations that require relatively low processing power and/or operations that require a relatively low latency, whereas the user device 106 may transmit the data to the servers 110 for processing operations that require relatively high processing power and/or operations that may allow relatively higher latency.

In some aspects, the ring 104, user device 106, and server 110 of the system 500 may be configured to evaluate sleep patterns for a user. In particular, the respective components of the system 500 may be used to collect data from a user via the ring 104, and generate one or more scores (e.g., Sleep Score, Readiness Score) for the user based on the collected data. For example, as noted previously herein, the ring 104 of the system 500 may be worn by a user to collect data from the user, including temperature, heart rate, HRV, and the like. Data collected by the ring 104 may be used to determine when the user is asleep in order to evaluate the user's sleep for a given “sleep day.” In some aspects, scores may be calculated for the user for each respective sleep day, such that a first sleep day is associated with a first set of scores, and a second sleep day is associated with a second set of scores. Scores may be calculated for each respective sleep day based on data collected by the ring 104 during the respective sleep day. Scores may include, but are not limited to, Sleep Scores, Readiness Scores, and the like.

In some cases, “sleep days” may align with the traditional calendar days, such that a given sleep day runs from midnight to midnight of the respective calendar day. In other cases, sleep days may be offset relative to calendar days. For example, sleep days may run from 6:00 pm (18:00) of a calendar day until 6:00 pm (18:00) of the subsequent calendar day. In this example, 6:00 pm may serve as a “cut-off time,” where data collected from the user before 6:00 pm is counted for the current sleep day, and data collected from the user after 6:00 pm is counted for the subsequent sleep day. Due to the fact that most individuals sleep the most at night, offsetting sleep days relative to calendar days may enable the system 500 to evaluate sleep patterns for users in such a manner that is consistent with their sleep schedules. In some cases, users may be able to selectively adjust (e.g., via the GUI) a timing of sleep days relative to calendar days so that the sleep days are aligned with the duration of time that the respective users typically sleep.

In some implementations, each overall score for a user for each respective day (e.g., Sleep Score, Readiness Score) may be determined/calculated based on one or more “contributors,” “factors,” or “contributing factors.” For example, a user's overall Sleep Score may be calculated based on a set of contributors, including: total sleep, efficiency, restfulness, REM sleep, deep sleep, latency, timing, or any combination thereof. The Sleep Score may include any quantity of contributors. The “total sleep” contributor may refer to the sum of all sleep periods of the sleep day. The “efficiency” contributor may reflect the percentage of time spent asleep compared to time spent awake while in bed, and may be calculated using the efficiency average of long sleep periods (e.g., primary sleep period) of the sleep day, weighted by a duration of each sleep period. The “restfulness” contributor may indicate how restful the user's sleep is, and may be calculated using the average of all sleep periods of the sleep day, weighted by a duration of each period. The restfulness contributor may be based on a “wake up count” (e.g., sum of all the wake-ups (when user wakes up) detected during different sleep periods), excessive movement, and a “got up count” (e.g., sum of all the got-ups (when user gets out of bed) detected during the different sleep periods).

The “REM sleep” contributor may refer to a sum total of REM sleep durations across all sleep periods of the sleep day including REM sleep. Similarly, the “deep sleep” contributor may refer to a sum total of deep sleep durations across all sleep periods of the sleep day including deep sleep. The “latency” contributor may signify how long (e.g., average, median, longest) the user takes to go to sleep, and may be calculated using the average of long sleep periods throughout the sleep day, weighted by a duration of each period and the number of such periods (e.g., consolidation of a given sleep stage or sleep stages may be its own contributor or weight other contributors). Lastly, the “timing” contributor may refer to a relative timing of sleep periods within the sleep day and/or calendar day, and may be calculated using the average of all sleep periods of the sleep day, weighted by a duration of each period.

By way of another example, a user's overall Readiness Score may be calculated based on a set of contributors, including: sleep, sleep balance, heart rate, HRV balance, recovery index, temperature, activity, activity balance, or any combination thereof. The Readiness Score may include any quantity of contributors. The “sleep” contributor may refer to the combined Sleep Score of all sleep periods within the sleep day. The “sleep balance” contributor may refer to a cumulative duration of all sleep periods within the sleep day. In particular, sleep balance may indicate to a user whether the sleep that the user has been getting over some duration of time (e.g., the past two weeks) is in balance with the user's needs. Typically, adults need 7-9 hours of sleep a night to stay healthy, alert, and to perform at their best both mentally and physically. However, it is normal to have an occasional night of bad sleep, so the sleep balance contributor takes into account long-term sleep patterns to determine whether each user's sleep needs are being met. The “resting heart rate” contributor may indicate a lowest heart rate from the longest sleep period of the sleep day (e.g., primary sleep period) and/or the lowest heart rate from naps occurring after the primary sleep period.

Continuing with reference to the “contributors” (e.g., factors, contributing factors) of the Readiness Score, the “HRV balance” contributor may indicate a highest HRV average from the primary sleep period and the naps happening after the primary sleep period. The HRV balance contributor may help users keep track of their recovery status by comparing their HRV trend over a first time period (e.g., two weeks) to an average HRV over some second, longer time period (e.g., three months). The “recovery index” contributor may be calculated based on the longest sleep period. Recovery index measures how long it takes for a user's resting heart rate to stabilize during the night. A sign of a very good recovery is that the user's resting heart rate stabilizes during the first half of the night, at least six hours before the user wakes up, leaving the body time to recover for the next day. The “body temperature” contributor may be calculated based on the longest sleep period (e.g., primary sleep period) or based on a nap happening after the longest sleep period if the user's highest temperature during the nap is at least 0.5° C. higher than the highest temperature during the longest period. In some aspects, the ring may measure a user's body temperature while the user is asleep, and the system 500 may display the user's average temperature relative to the user's baseline temperature. If a user's body temperature is outside of their normal range (e.g., clearly above or below 0.0), the body temperature contributor may be highlighted (e.g., go to a “Pay attention” state) or otherwise generate an alert for the user.

In some aspects, the system 500 may support techniques for modulating the charging power to transmit the charger diagnostic data while the wearable device is charging. For example, the charger outputs power to charge the wearable device while also outputting charger diagnostic data. After the charger diagnostic data is sent, the charger continues to charge the wearable device with power equal to or greater than a level of power used to charge the wearable device while transmitting the charger diagnostic data. The wearable receives charger diagnostic data during the charging session and relays the charger diagnostic data to an application on a mobile device.

In some cases, the system 500 may use the inductive charging interface to perform over-the-air updates (e.g., firmware updates) for the charger. In some examples, the system 500 may may communicate a request for the charger diagnostic data, transfer sensed data (e.g., environmental data) from the charger to the wearable device, and store the charger diagnostic data at the wearable device.

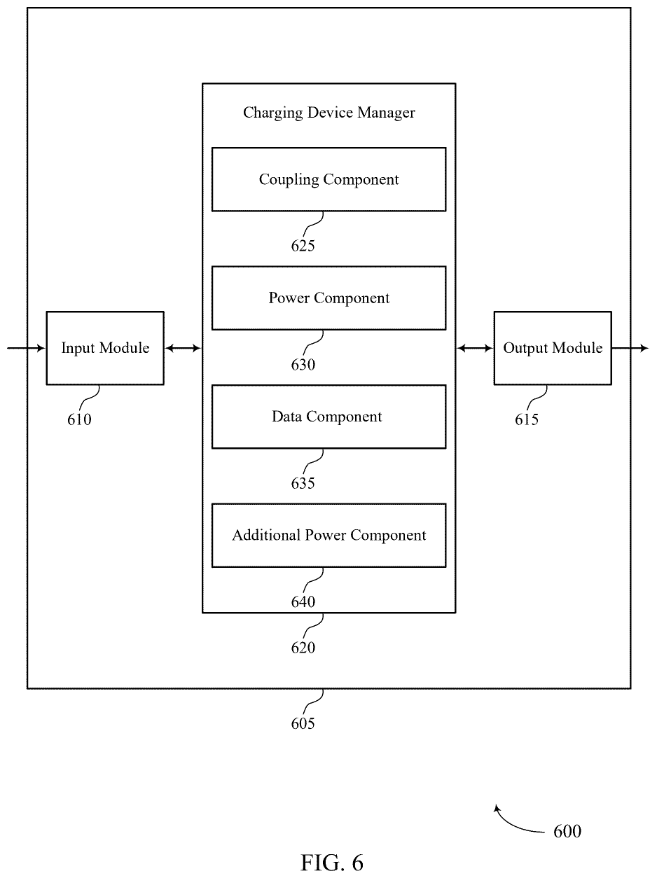

FIG. 6 shows a block diagram 600 of a device 605 that supports charger diagnostics and updates via a charging interface in accordance with aspects of the present disclosure. The device 605 may include an input module 610, an output module 615, and a charging device manager 620. The device 605, or one or more components of the device 605 (e.g., the input module 610, the output module 615, the charging device manager 620), may include at least one processor, which may be coupled with at least one memory, to support the described techniques. Each of these components may be in communication with one another (e.g., via one or more buses).

The input module 610 may provide a means for receiving information such as packets, user data, control information, or any combination thereof associated with various information channels (e.g., control channels, data channels, information channels related to illness detection techniques). Information may be passed on to other components of the device 605. The input module 610 may utilize a single antenna or a set of multiple antennas.

The output module 615 may provide a means for transmitting signals generated by other components of the device 605. For example, the output module 615 may transmit information such as packets, user data, control information, or any combination thereof associated with various information channels (e.g., control channels, data channels, information channels related to illness detection techniques). In some examples, the output module 615 may be co-located with the input module 610 in a transceiver module. The output module 615 may utilize a single antenna or a set of multiple antennas.

For example, the charging device manager 620 may include a coupling component 625, a power component 630, a data component 635, an additional power component 640, or any combination thereof. In some examples, the charging device manager 620, or various components thereof, may be configured to perform various operations (e.g., receiving, monitoring, transmitting) using or otherwise in cooperation with the input module 610, the output module 615, or both. For example, the charging device manager 620 may receive information from the input module 610, send information to the output module 615, or be integrated in combination with the input module 610, the output module 615, or both to receive information, transmit information, or perform various other operations as described herein.

The coupling component 625 may be configured as or otherwise support a means for detecting, at a charging device, that a wearable device is coupled to the charging device. The power component 630 may be configured as or otherwise support a means for outputting, from the charging device, power to charge the wearable device during a charging session for the wearable device, the power output via an inductive charging link between the charging device and the wearable device based at least in part on detecting that the wearable device is coupled to the charging device. The data component 635 may be configured as or otherwise support a means for outputting, from the charging device and to the wearable device via the inductive charging link as part of the charging session, charger diagnostic data associated with one or more inductive charging components of the charging device, wherein the inductive charging link is formed using the one or more inductive charging components. The additional power component 640 may be configured as or otherwise support a means for outputting, from the charging device and to the wearable device via the inductive charging link as part of the charging session, additional power to charge the wearable device during the charging session based at least in part on outputting the charger diagnostic data.

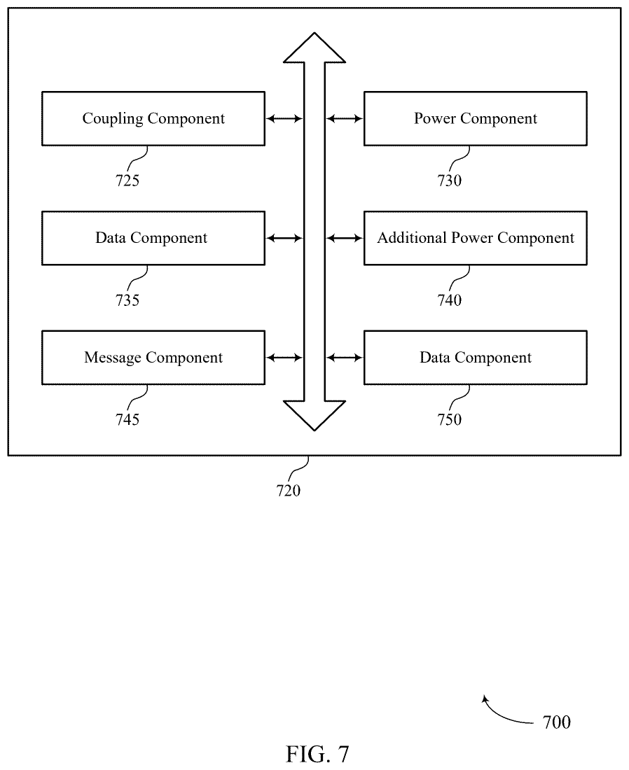

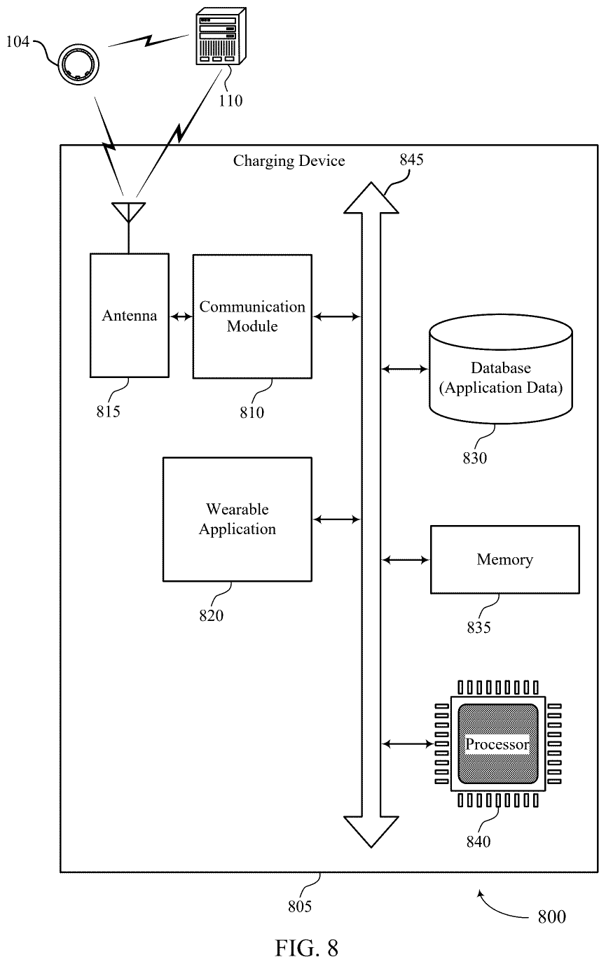

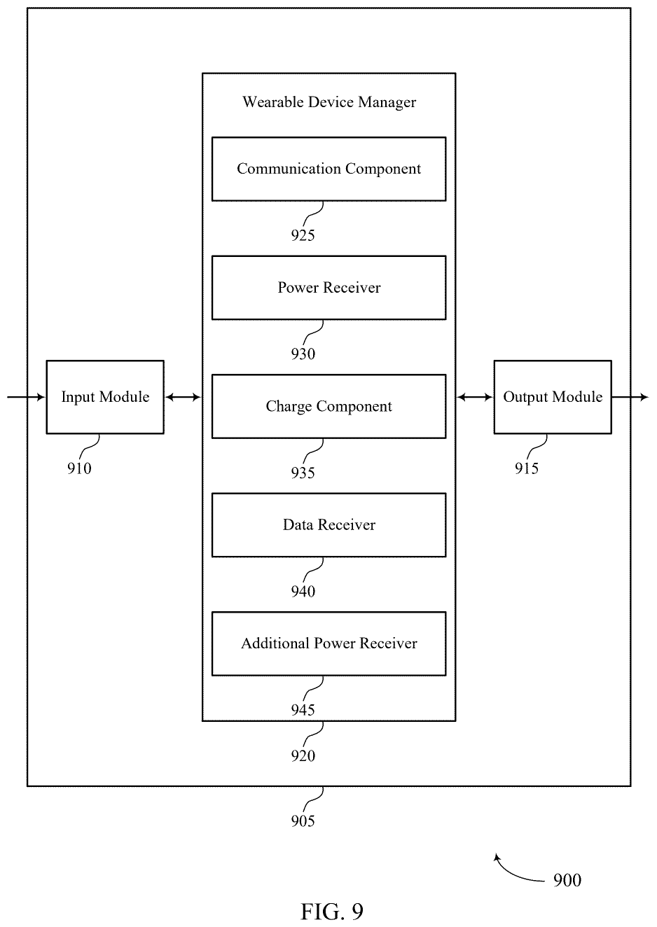

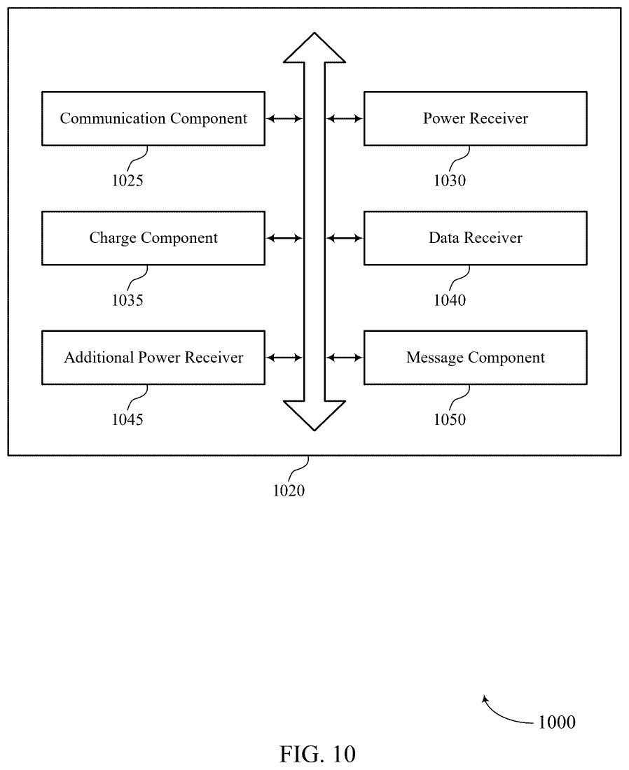

FIG. 7 shows a block diagram 700 of a charging device manager 720 that supports charger diagnostics and updates via a charging interface in accordance with aspects of the present disclosure. The charging device manager 720 may be an example of aspects of a wearable application or a charging device manager 620, or both, as described herein. The charging device manager 720, or various components thereof, may be an example of means for performing various aspects of charger diagnostics and updates via a charging interface as described herein. For example, the charging device manager 720 may include a coupling component 725, a power component 730, a data component 735, an additional power component 740, a message component 745, a data component 750, or any combination thereof. Each of these components, or components of subcomponents thereof (e.g., one or more processors, one or more memories), may communicate, directly or indirectly, with one another (e.g., via one or more buses).

The coupling component 725 may be configured as or otherwise support a means for detecting, at a charging device, that a wearable device is coupled to the charging device. The power component 730 may be configured as or otherwise support a means for outputting, from the charging device, power to charge the wearable device during a charging session for the wearable device, the power output via an inductive charging link between the charging device and the wearable device based at least in part on detecting that the wearable device is coupled to the charging device. The data component 735 may be configured as or otherwise support a means for outputting, from the charging device and to the wearable device via the inductive charging link as part of the charging session, charger diagnostic data associated with one or more inductive charging components of the charging device, wherein the inductive charging link is formed using the one or more inductive charging components. The additional power component 740 may be configured as or otherwise support a means for outputting, from the charging device and to the wearable device via the inductive charging link as part of the charging session, additional power to charge the wearable device during the charging session based at least in part on outputting the charger diagnostic data.

In some examples, the power output via the inductive charging link is associated with a first power level used to charge the wearable device during a first portion of the charging session. In some examples, the additional power output via the inductive charging link is associated with a second power level used to charge the wearable device during a second portion of the charging session. In some examples, the second power level is greater than or equal to the first power level.

In some examples, the first power level is associated with a first charging rate of the wearable device during the first portion of the charging session. In some examples, the second power level is associated with a second charging rate of the wearable device during the second portion of the charging session. In some examples, the second charging rate is greater than or equal to the first charging rate.

In some examples, the charger diagnostic data is output during the first portion of the charging session associated with the first power level.

In some examples, the power output via the inductive charging link is associated with a first power level used to charge the wearable device during a first portion of the charging session, and wherein the additional power output via the inductive charging link is associated with a second power level used to charge the wearable device during a second portion of the charging session, wherein the second power level is less than to the first power level.

In some examples, the message component 745 may be configured as or otherwise support a means for receiving, at the charging device and from the wearable device via the inductive charging link, a request for the charger diagnostic data based at least in part on the power output via the inductive charging link between the charging device and the wearable device, wherein the charger diagnostic data is output in response to the request.

In some examples, the message component 745 may be configured as or otherwise support a means for receiving, at the charging device and from the wearable device via the inductive charging link, one or more messages associated with a firmware update for the charging device based at least in part on the charger diagnostic data. In some examples, the data component 750 may be configured as or otherwise support a means for implementing the firmware update at the charging device using one or more processors of the charging device.

In some examples, the data component 750 may be configured as or otherwise support a means for outputting, from the charging device and to the wearable device via the inductive charging link, data acquired using one or more sensors of the charging device.

In some examples, the data component 750 may be configured as or otherwise support a means for performing, by the charging device, one or more diagnostic procedures, wherein outputting the charger diagnostic data is based at least in part on performing the one or more diagnostic procedures.

In some examples, the charger diagnostic data comprises a firmware version of the charging device, a serial number of the charging device, a size of the charging device, a manufacturer of the charging device, a hardware version of the charging device, an input voltage of the charging device, a supply voltage associated with the one or more inductive charging components, information associated with an internal pin check, statistics associated with the charging session, statistics associated with the charging session, or any combination thereof.

In some examples, the data component 750 may be configured as or otherwise support a means for outputting, from the charging device to the wearable device via the inductive charging link as part of the charging session, sensor data acquired via one or more sensors of the charging device.

FIG. 8 shows a diagram of a system 800 including a device 805 that supports charger diagnostics and updates via a charging interface in accordance with aspects of the present disclosure. The device 805 may be an example of or include components of a device 605 as described herein. The device 805 may include an example of a charging device, as described previously herein. The device 805 may include components for bi-directional communications including components for transmitting and receiving communications with a ring 104 and a server 110, such as a wearable application 820, a communication module 810, one or more antennas 815, a database (application data) 830, at least one memory 835, and at least one processor 840. These components may be in electronic communication or otherwise coupled (e.g., operatively, communicatively, functionally, electronically, electrically) via one or more buses (e.g., a bus 845).

The communication module 810 may manage input and output signals for the device 805 via the antenna 815. The communication module 810 may include an example of the communication module 220-b of the user device 106 shown and described in FIG. 2. In this regard, the communication module 810 may manage communications with the ring 104 and the server 110, as illustrated in FIG. 2. The communication module 810 may also manage peripherals not integrated into the device 805. In some cases, the communication module 810 may represent a physical connection or port to an external peripheral. In some cases, the communication module 810 may utilize an operating system such as iOS®, ANDROID®, MS-DOS®, MS-WINDOWS®, OS/2®, UNIX®, LINUX®, or another known operating system. In other cases, the communication module 810 may represent or interact with a wearable device (e.g., ring 104), modem, a keyboard, a mouse, a touchscreen, or a similar device. In some cases, the communication module 810 may be implemented as part of the processor 840. In some examples, a user may interact with the device 805 via the communication module 810, or via hardware components controlled by the communication module 810.

In some cases, the device 805 may include a single antenna 815. However, in some other cases, the device 805 may have more than one antenna 815, which may be capable of concurrently transmitting or receiving multiple wireless transmissions. The communication module 810 may communicate bi-directionally, via the one or more antennas 815, wired, or wireless links as described herein. For example, the communication module 810 may represent a wireless transceiver and may communicate bi-directionally with another wireless transceiver. The communication module 810 may also include a modem to modulate the packets, to provide the modulated packets to one or more antennas 815 for transmission, and to demodulate packets received from the one or more antennas 815.

The processor(s) 840 may manage data storage and processing in a database 830. The database 830 may be an example of a single database, a distributed database, multiple distributed databases, a data store, a data lake, or an emergency backup database.

The memory 835 may include RAM and ROM. The memory 835 may store computer-readable, computer-executable software including instructions that, when executed, cause the processor 840 to perform various functions described herein. In some cases, the memory 835 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory 835 to perform various functions (e.g., functions or tasks supporting a method and system for sleep staging algorithms).

For example, the wearable application 820 may be configured as or otherwise support a means for detecting, at a charging device, that a wearable device is coupled to the charging device. The wearable application 820 may be configured as or otherwise support a means for outputting, from the charging device, power to charge the wearable device during a charging session for the wearable device, the power output via an inductive charging link between the charging device and the wearable device based at least in part on detecting that the wearable device is coupled to the charging device. The wearable application 820 may be configured as or otherwise support a means for outputting, from the charging device and to the wearable device via the inductive charging link as part of the charging session, charger diagnostic data associated with one or more inductive charging components of the charging device, wherein the inductive charging link is formed using the one or more inductive charging components. The wearable application 820 may be configured as or otherwise support a means for outputting, from the charging device and to the wearable device via the inductive charging link as part of the charging session, additional power to charge the wearable device during the charging session based at least in part on outputting the charger diagnostic data.

By including or configuring the wearable application 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, and the like.

The wearable application 820 may include an application (e.g., “app”), program, software, or other component which is configured to facilitate communications with a ring 104, server 110, other user devices 106, and the like. For example, the wearable application 820 may include an application executable on a user device 106 which is configured to receive data (e.g., physiological data) from a ring 104, perform processing operations on the received data, transmit and receive data with the servers 110, and cause presentation of data to a user 102.

FIG. 9 shows a block diagram 900 of a device 905 that supports charger diagnostics and updates via a charging interface in accordance with aspects of the present disclosure. The device 905 may include an input module 910, an output module 915, and a wearable device manager 920. The device 905, or one or more components of the device 905 (e.g., the input module 910, the output module 915, the wearable device manager 920), may include at least one processor, which may be coupled with at least one memory, to support the described techniques. Each of these components may be in communication with one another (e.g., via one or more buses).

For example, the wearable device manager 920 may include a communication component 925, a power receiver 930, a charge component 935, a data receiver 940, an additional power receiver 945, or any combination thereof. In some examples, the wearable device manager 920, or various components thereof, may be configured to perform various operations (e.g., receiving, monitoring, transmitting) using or otherwise in cooperation with the input module 910, the output module 915, or both. For example, the wearable device manager 920 may receive information from the input module 910, send information to the output module 915, or be integrated in combination with the input module 910, the output module 915, or both to receive information, transmit information, or perform various other operations as described herein.

The communication component 925 may be configured as or otherwise support a means for activating, at a wearable device, charging-based communication circuitry of the wearable device based at least in part on the wearable device being coupled to a charging device. The power receiver 930 may be configured as or otherwise support a means for receiving, at the wearable device, power from the charging device via the charging-based communication circuitry during a charging session for the wearable device, the power received via an inductive charging link between the charging device and the wearable device. The charge component 935 may be configured as or otherwise support a means for recharging, at the wearable device, a battery of the wearable device using the power received via the inductive charging link. The data receiver 940 may be configured as or otherwise support a means for receiving, at the wearable device and from the charging device via the inductive charging link as part of the charging session, charger diagnostic data associated with one or more inductive charging components of the charging device, wherein the inductive charging link is formed using the one or more inductive charging components. The additional power receiver 945 may be configured as or otherwise support a means for receiving, at the wearable device and from the charging device via the inductive charging link as part of the charging session, additional power to charge the wearable device during the charging session based at least in part on receiving the charger diagnostic data.

FIG. 10 shows a block diagram 1000 of a wearable device manager 1020 that supports charger diagnostics and updates via a charging interface in accordance with aspects of the present disclosure. The wearable device manager 1020 may be an example of aspects of a wearable device manager or a wearable device manager 920, or both, as described herein. The wearable device manager 1020, or various components thereof, may be an example of means for performing various aspects of charger diagnostics and updates via a charging interface as described herein. For example, the wearable device manager 1020 may include a communication component 1025, a power receiver 1030, a charge component 1035, a data receiver 1040, an additional power receiver 1045, a message component 1050, or any combination thereof. Each of these components, or components of subcomponents thereof (e.g., one or more processors, one or more memories), may communicate, directly or indirectly, with one another (e.g., via one or more buses).

The communication component 1025 may be configured as or otherwise support a means for activating, at a wearable device, charging-based communication circuitry of the wearable device based at least in part on the wearable device being coupled to a charging device. The power receiver 1030 may be configured as or otherwise support a means for receiving, at the wearable device, power from the charging device via the charging-based communication circuitry during a charging session for the wearable device, the power received via an inductive charging link between the charging device and the wearable device. The charge component 1035 may be configured as or otherwise support a means for recharging, at the wearable device, a battery of the wearable device using the power received via the inductive charging link. The data receiver 1040 may be configured as or otherwise support a means for receiving, at the wearable device and from the charging device via the inductive charging link as part of the charging session, charger diagnostic data associated with one or more inductive charging components of the charging device, wherein the inductive charging link is formed using the one or more inductive charging components. The additional power receiver 1045 may be configured as or otherwise support a means for receiving, at the wearable device and from the charging device via the inductive charging link as part of the charging session, additional power to charge the wearable device during the charging session based at least in part on receiving the charger diagnostic data.

In some examples, the power received via the inductive charging link is associated with a first power level used to charge the wearable device during a first portion of the charging session. In some examples, the additional power received via the inductive charging link is associated with a second power level used to charge the wearable device during a second portion of the charging session. In some examples, the second power level is greater than or equal to the first power level.

In some examples, the first power level is associated with a first charging rate of the wearable device during the first portion of the charging session. In some examples, the second power level is associated with a second charging rate of the wearable device during the second portion of the charging session. In some examples, the second charging rate is greater than or equal to the first charging rate.

In some examples, the charger diagnostic data is received during the first portion of the charging session associated with the first power level.

In some examples, the power output via the inductive charging link is associated with a first power level used to charge the wearable device during a first portion of the charging session, and wherein the additional power output via the inductive charging link is associated with a second power level used to charge the wearable device during a second portion of the charging session, wherein the second power level is less than to the first power level.

In some examples, the message component 1050 may be configured as or otherwise support a means for outputting, from the wearable device and to the charging device and via the inductive charging link, a request for the charger diagnostic data based at least in part on receiving the power from the charging device.

In some examples, the message component 1050 may be configured as or otherwise support a means for outputting, from the wearable device and to the charging device and via the inductive charging link, one or more messages associated with a firmware update for the charging device based at least in part on receiving the charger diagnostic data.

In some examples, the data receiver 1040 may be configured as or otherwise support a means for receiving, at the wearable device and from the charging device via the inductive charging link, one or more messages associated with data acquired using one or more sensors of the charging device.

In some examples, the data receiver 1040 may be configured as or otherwise support a means for receiving, at the wearable device via communication circuitry and from an application of a user device, a request for the charger diagnostic data. In some examples, the message component 1050 may be configured as or otherwise support a means for outputting, from the wearable device and to the application via the communication circuitry, the charger diagnostic data after the charging session is completed.

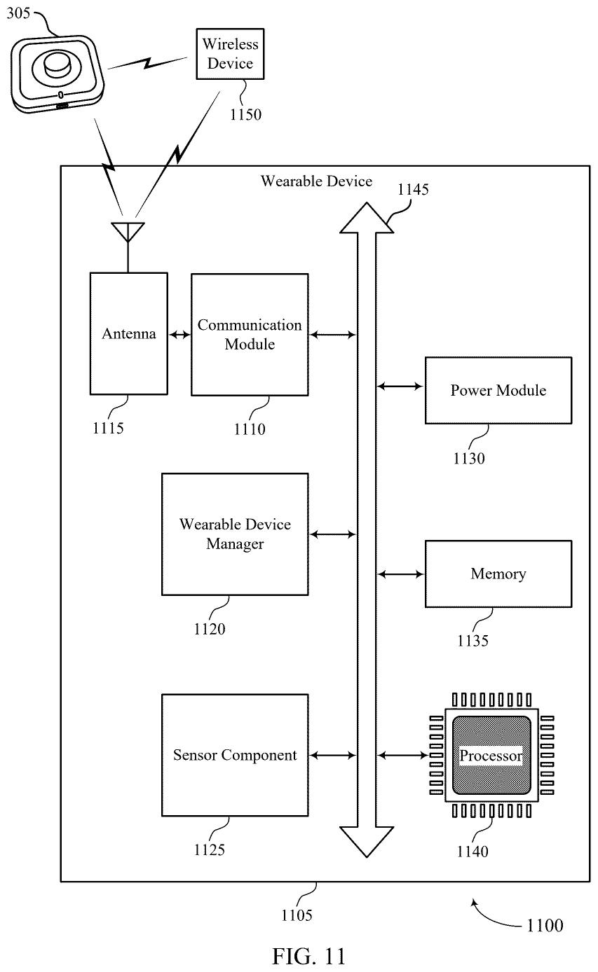

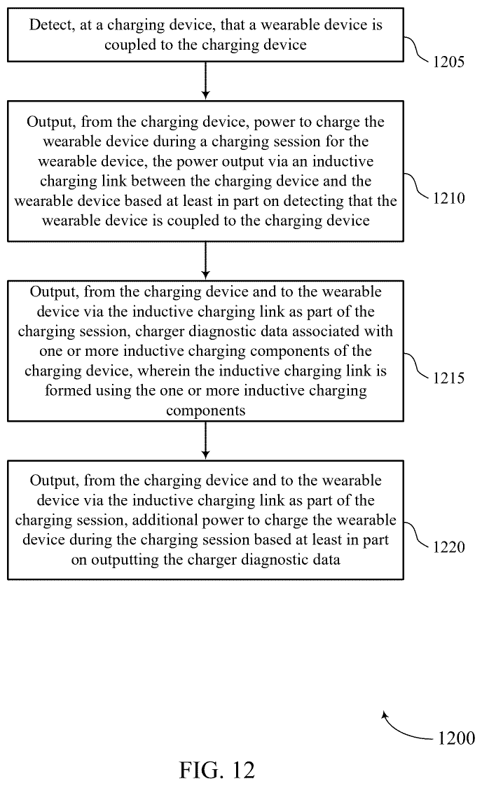

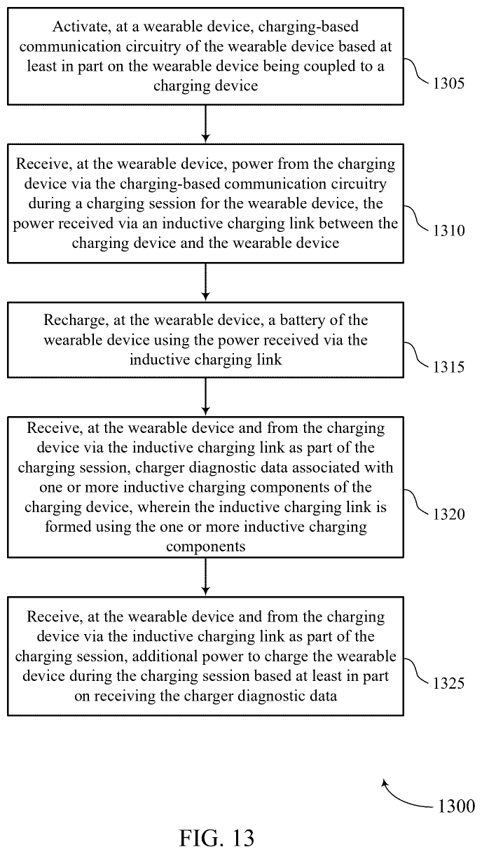

FIG. 11 shows a diagram of a system 1100 including a device 1105 that supports charger diagnostics and updates via a charging interface in accordance with aspects of the present disclosure. The device 1105 may be an example of or include components of a device 905 as described herein. The device 1105 may include an example of a wearable device 104, as described previously herein. The device 1105 may include components for bi-directional communications including components for transmitting and receiving communications with a charging device 405 and a server 110, such as a wearable device manager 1120, a communication module 1110, one or more antennas 1115, a sensor component 1125, a power module 1130, at least one memory 1135, at least one processor 1140, and a wireless device 1150. These components may be in electronic communication or otherwise coupled (e.g., operatively, communicatively, functionally, electronically, electrically) via one or more buses (e.g., a bus 1145).

For example, the wearable device manager 1120 may be configured as or otherwise support a means for activating, at a wearable device, charging-based communication circuitry of the wearable device based at least in part on the wearable device being coupled to a charging device. The wearable device manager 1120 may be configured as or otherwise support a means for receiving, at the wearable device, power from the charging device via the charging-based communication circuitry during a charging session for the wearable device, the power received via an inductive charging link between the charging device and the wearable device. The wearable device manager 1120 may be configured as or otherwise support a means for recharging, at the wearable device, a battery of the wearable device using the power received via the inductive charging link. The wearable device manager 1120 may be configured as or otherwise support a means for receiving, at the wearable device and from the charging device via the inductive charging link as part of the charging session, charger diagnostic data associated with one or more inductive charging components of the charging device, wherein the inductive charging link is formed using the one or more inductive charging components. The wearable device manager 1120 may be configured as or otherwise support a means for receiving, at the wearable device and from the charging device via the inductive charging link as part of the charging session, additional power to charge the wearable device during the charging session based at least in part on receiving the charger diagnostic data.

By including or configuring the wearable device manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

FIG. 12 shows a flowchart illustrating a method 1200 that supports charger diagnostics and updates via a charging interface in accordance with aspects of the present disclosure. The operations of the method 1200 may be implemented by a charging device or its components as described herein. For example, the operations of the method 1200 may be performed by a charging device as described with reference to FIGS. 4 through 8. In some examples, a charging device may execute a set of instructions to control the functional elements of the charging device to perform the described functions. Additionally, or alternatively, the charging device may perform aspects of the described functions using special-purpose hardware.

At 1205, the method may include detecting, at a charging device, that a wearable device is coupled to the charging device. The operations of 1205 may be performed in accordance with examples as disclosed herein. In some examples, aspects of the operations of 1205 may be performed by a coupling component 725 as described with reference to FIG. 7.

At 1210, the method may include outputting, from the charging device, power to charge the wearable device during a charging session for the wearable device, the power output via an inductive charging link between the charging device and the wearable device based at least in part on detecting that the wearable device is coupled to the charging device. The operations of 1210 may be performed in accordance with examples as disclosed herein. In some examples, aspects of the operations of 1210 may be performed by a power component 730 as described with reference to FIG. 7.

At 1215, the method may include outputting, from the charging device and to the wearable device via the inductive charging link as part of the charging session, charger diagnostic data associated with one or more inductive charging components of the charging device, wherein the inductive charging link is formed using the one or more inductive charging components. The operations of 1215 may be performed in accordance with examples as disclosed herein. In some examples, aspects of the operations of 1215 may be performed by a data component 735 as described with reference to FIG. 7.

At 1220, the method may include outputting, from the charging device and to the wearable device via the inductive charging link as part of the charging session, additional power to charge the wearable device during the charging session based at least in part on outputting the charger diagnostic data. The operations of 1220 may be performed in accordance with examples as disclosed herein. In some examples, aspects of the operations of 1220 may be performed by an additional power component 740 as described with reference to FIG. 7.

FIG. 13 shows a flowchart illustrating a method 1300 that supports charger diagnostics and updates via a charging interface in accordance with aspects of the present disclosure. The operations of the method 1300 may be implemented by a wearable device or its components as described herein. For example, the operations of the method 1300 may be performed by a wearable device as described with reference to FIGS. 4 through 3 and 9 through 11. In some examples, a wearable device may execute a set of instructions to control the functional elements of the wearable device to perform the described functions. Additionally, or alternatively, the wearable device may perform aspects of the described functions using special-purpose hardware.

At 1305, the method may include activating, at a wearable device, charging-based communication circuitry of the wearable device based at least in part on the wearable device being coupled to a charging device. The operations of 1305 may be performed in accordance with examples as disclosed herein. In some examples, aspects of the operations of 1305 may be performed by a communication component 1025 as described with reference to FIG. 10.

At 1310, the method may include receiving, at the wearable device, power from the charging device via the charging-based communication circuitry during a charging session for the wearable device, the power received via an inductive charging link between the charging device and the wearable device. The operations of 1310 may be performed in accordance with examples as disclosed herein. In some examples, aspects of the operations of 1310 may be performed by a power receiver 1030 as described with reference to FIG. 10.

At 1315, the method may include recharging, at the wearable device, a battery of the wearable device using the power received via the inductive charging link. The operations of 1315 may be performed in accordance with examples as disclosed herein. In some examples, aspects of the operations of 1315 may be performed by a charge component 1035 as described with reference to FIG. 10.

At 1320, the method may include receiving, at the wearable device and from the charging device via the inductive charging link as part of the charging session, charger diagnostic data associated with one or more inductive charging components of the charging device, wherein the inductive charging link is formed using the one or more inductive charging components. The operations of 1320 may be performed in accordance with examples as disclosed herein. In some examples, aspects of the operations of 1320 may be performed by a data receiver 1040 as described with reference to FIG. 10.

At 1325, the method may include receiving, at the wearable device and from the charging device via the inductive charging link as part of the charging session, additional power to charge the wearable device during the charging session based at least in part on receiving the charger diagnostic data. The operations of 1325 may be performed in accordance with examples as disclosed herein. In some examples, aspects of the operations of 1325 may be performed by an additional power receiver 1045 as described with reference to FIG. 10.

It should be noted that the methods described above describe possible implementations, and that the operations and the steps may be rearranged or otherwise modified and that other implementations are possible. Furthermore, aspects from two or more of the methods may be combined.

A method by an apparatus is described. The method may include detecting, at a charging device, that a wearable device is coupled to the charging device, outputting, from the charging device, power to charge the wearable device during a charging session for the wearable device, the power output via an inductive charging link between the charging device and the wearable device based at least in part on detecting that the wearable device is coupled to the charging device, outputting, from the charging device and to the wearable device via the inductive charging link as part of the charging session, charger diagnostic data associated with one or more inductive charging components of the charging device, wherein the inductive charging link is formed using the one or more inductive charging components, and outputting, from the charging device and to the wearable device via the inductive charging link as part of the charging session, additional power to charge the wearable device during the charging session based at least in part on outputting the charger diagnostic data.

An apparatus is described. The apparatus may include one or more memories storing processor executable code, and one or more processors coupled with the one or more memories. The one or more processors may individually or collectively be operable to execute the code to cause the apparatus to detect, at a charging device, that a wearable device is coupled to the charging device, output, from the charging device, power to charge the wearable device during a charging session for the wearable device, the power output via an inductive charging link between the charging device and the wearable device based at least in part on detecting that the wearable device is coupled to the charging device, output, from the charging device and to the wearable device via the inductive charging link as part of the charging session, charger diagnostic data associated with one or more inductive charging components of the charging device, wherein the inductive charging link is formed using the one or more inductive charging components, and output, from the charging device and to the wearable device via the inductive charging link as part of the charging session, additional power to charge the wearable device during the charging session based at least in part on outputting the charger diagnostic data.

Another apparatus is described. The apparatus may include means for detecting, at a charging device, that a wearable device is coupled to the charging device, means for outputting, from the charging device, power to charge the wearable device during a charging session for the wearable device, the power output via an inductive charging link between the charging device and the wearable device based at least in part on detecting that the wearable device is coupled to the charging device, means for outputting, from the charging device and to the wearable device via the inductive charging link as part of the charging session, charger diagnostic data associated with one or more inductive charging components of the charging device, wherein the inductive charging link is formed using the one or more inductive charging components, and means for outputting, from the charging device and to the wearable device via the inductive charging link as part of the charging session, additional power to charge the wearable device during the charging session based at least in part on outputting the charger diagnostic data.

A non-transitory computer-readable medium storing code is described. The code may include instructions executable by one or more processors to detect, at a charging device, that a wearable device is coupled to the charging device, output, from the charging device, power to charge the wearable device during a charging session for the wearable device, the power output via an inductive charging link between the charging device and the wearable device based at least in part on detecting that the wearable device is coupled to the charging device, output, from the charging device and to the wearable device via the inductive charging link as part of the charging session, charger diagnostic data associated with one or more inductive charging components of the charging device, wherein the inductive charging link is formed using the one or more inductive charging components, and output, from the charging device and to the wearable device via the inductive charging link as part of the charging session, additional power to charge the wearable device during the charging session based at least in part on outputting the charger diagnostic data.

In some examples of the method, apparatus, and non-transitory computer-readable medium described herein, the power output via the inductive charging link may be associated with a first power level used to charge the wearable device during a first portion of the charging session, the additional power output via the inductive charging link may be associated with a second power level used to charge the wearable device during a second portion of the charging session, and the second power level may be greater than or equal to the first power level.

In some examples of the method, apparatus, and non-transitory computer-readable medium described herein, the first power level may be associated with a first charging rate of the wearable device during the first portion of the charging session, the second power level may be associated with a second charging rate of the wearable device during the second portion of the charging session, and the second charging rate may be greater than or equal to the first charging rate.

In some examples of the method, apparatus, and non-transitory computer-readable medium described herein, the charger diagnostic data may be output during the first portion of the charging session associated with the first power level.

In some examples of the method, apparatus, and non-transitory computer-readable medium described herein, the power output via the inductive charging link is associated with a first power level used to charge the wearable device during a first portion of the charging session, and wherein the additional power output via the inductive charging link is associated with a second power level used to charge the wearable device during a second portion of the charging session, wherein the second power level is less than to the first power level.

Some examples of the method, apparatus, and non-transitory computer-readable medium described herein may further include operations, features, means, or instructions for receiving, at the charging device and from the wearable device via the inductive charging link, a request for the charger diagnostic data based at least in part on the power output via the inductive charging link between the charging device and the wearable device, wherein the charger diagnostic data may be output in response to the request.

Some examples of the method, apparatus, and non-transitory computer-readable medium described herein may further include operations, features, means, or instructions for receiving, at the charging device and from the wearable device via the inductive charging link, one or more messages associated with a firmware update for the charging device based at least in part on the charger diagnostic data and implementing the firmware update at the charging device using one or more processors of the charging device.

Some examples of the method, apparatus, and non-transitory computer-readable medium described herein may further include operations, features, means, or instructions for outputting, from the charging device and to the wearable device via the inductive charging link, data acquired using one or more sensors of the charging device.

Some examples of the method, apparatus, and non-transitory computer-readable medium described herein may further include operations, features, means, or instructions for performing, by the charging device, one or more diagnostic procedures, wherein outputting the charger diagnostic data may be based at least in part on performing the one or more diagnostic procedures.

In some examples of the method, apparatus, and non-transitory computer-readable medium described herein, the charger diagnostic data comprises a firmware version of the charging device, a serial number of the charging device, a size of the charging device, a manufacturer of the charging device, a hardware version of the charging device, an input voltage of the charging device, a supply voltage associated with the one or more inductive charging components, information associated with an internal pin check, statistics associated with the charging session, or any combination thereof.

Some examples of the method, apparatus, and non-transitory computer-readable medium described herein may further include operations, features, means, or instructions for outputting, from the charging device to the wearable device via the inductive charging link as part of the charging session, sensor data acquired via one or more sensors of the charging device.

A method by an apparatus is described. The method may include activating, at a wearable device, charging-based communication circuitry of the wearable device based at least in part on the wearable device being coupled to a charging device, receiving, at the wearable device, power from the charging device via the charging-based communication circuitry during a charging session for the wearable device, the power received via an inductive charging link between the charging device and the wearable device, recharging, at the wearable device, a battery of the wearable device using the power received via the inductive charging link, receiving, at the wearable device and from the charging device via the inductive charging link as part of the charging session, charger diagnostic data associated with one or more inductive charging components of the charging device, wherein the inductive charging link is formed using the one or more inductive charging components, and receiving, at the wearable device and from the charging device via the inductive charging link as part of the charging session, additional power to charge the wearable device during the charging session based at least in part on receiving the charger diagnostic data.

An apparatus is described. The apparatus may include one or more memories storing processor executable code, and one or more processors coupled with the one or more memories. The one or more processors may individually or collectively be operable to execute the code to cause the apparatus to activate, at a wearable device, charging-based communication circuitry of the wearable device based at least in part on the wearable device being coupled to a charging device, receive, at the wearable device, power from the charging device via the charging-based communication circuitry during a charging session for the wearable device, the power received via an inductive charging link between the charging device and the wearable device, recharge, at the wearable device, a battery of the wearable device using the power received via the inductive charging link, receive, at the wearable device and from the charging device via the inductive charging link as part of the charging session, charger diagnostic data associated with one or more inductive charging components of the charging device, wherein the inductive charging link is formed using the one or more inductive charging components, and receive, at the wearable device and from the charging device via the inductive charging link as part of the charging session, additional power to charge the wearable device during the charging session based at least in part on receiving the charger diagnostic data.

Another apparatus is described. The apparatus may include means for activating, at a wearable device, charging-based communication circuitry of the wearable device based at least in part on the wearable device being coupled to a charging device, means for receiving, at the wearable device, power from the charging device via the charging-based communication circuitry during a charging session for the wearable device, the power received via an inductive charging link between the charging device and the wearable device, means for recharging, at the wearable device, a battery of the wearable device using the power received via the inductive charging link, means for receiving, at the wearable device and from the charging device via the inductive charging link as part of the charging session, charger diagnostic data associated with one or more inductive charging components of the charging device, wherein the inductive charging link is formed using the one or more inductive charging components, and means for receiving, at the wearable device and from the charging device via the inductive charging link as part of the charging session, additional power to charge the wearable device during the charging session based at least in part on receiving the charger diagnostic data.

A non-transitory computer-readable medium storing code is described. The code may include instructions executable by one or more processors to activate, at a wearable device, charging-based communication circuitry of the wearable device based at least in part on the wearable device being coupled to a charging device, receive, at the wearable device, power from the charging device via the charging-based communication circuitry during a charging session for the wearable device, the power received via an inductive charging link between the charging device and the wearable device, recharge, at the wearable device, a battery of the wearable device using the power received via the inductive charging link, receive, at the wearable device and from the charging device via the inductive charging link as part of the charging session, charger diagnostic data associated with one or more inductive charging components of the charging device, wherein the inductive charging link is formed using the one or more inductive charging components, and receive, at the wearable device and from the charging device via the inductive charging link as part of the charging session, additional power to charge the wearable device during the charging session based at least in part on receiving the charger diagnostic data.

In some examples of the method, apparatus, and non-transitory computer-readable medium described herein, the power received via the inductive charging link may be associated with a first power level used to charge the wearable device during a first portion of the charging session, the additional power received via the inductive charging link may be associated with a second power level used to charge the wearable device during a second portion of the charging session, and the second power level may be greater than or equal to the first power level.

In some examples of the method, apparatus, and non-transitory computer-readable medium described herein, the first power level may be associated with a first charging rate of the wearable device during the first portion of the charging session, the second power level may be associated with a second charging rate of the wearable device during the second portion of the charging session, and the second charging rate may be greater than or equal to the first charging rate.

In some examples of the method, apparatus, and non-transitory computer-readable medium described herein, the charger diagnostic data may be received during the first portion of the charging session associated with the first power level.

In some examples of the method, apparatus, and non-transitory computer-readable medium described herein, the power output via the inductive charging link is associated with a first power level used to charge the wearable device during a first portion of the charging session, and wherein the additional power output via the inductive charging link is associated with a second power level used to charge the wearable device during a second portion of the charging session, wherein the second power level is less than to the first power level.

Some examples of the method, apparatus, and non-transitory computer-readable medium described herein may further include operations, features, means, or instructions for outputting, from the wearable device and to the charging device and via the inductive charging link, a request for the charger diagnostic data based at least in part on receiving the power from the charging device.

Some examples of the method, apparatus, and non-transitory computer-readable medium described herein may further include operations, features, means, or instructions for outputting, from the wearable device and to the charging device and via the inductive charging link, one or more messages associated with a firmware update for the charging device based at least in part on receiving the charger diagnostic data.

Some examples of the method, apparatus, and non-transitory computer-readable medium described herein may further include operations, features, means, or instructions for receiving, at the wearable device and from the charging device via the inductive charging link, one or more messages associated with data acquired using one or more sensors of the charging device.

Some examples of the method, apparatus, and non-transitory computer-readable medium described herein may further include operations, features, means, or instructions for receiving, at the wearable device via communication circuitry and from an application of a user device, a request for the charger diagnostic data and outputting, from the wearable device and to the application via the communication circuitry, the charger diagnostic data after the charging session may be completed.

Another apparatus device for charging a wearable device, the charging device is described. The apparatus may include a charger housing configured to receive the wearable device, one or more inductive charging components configured to form an inductive charging link with a wearable device to recharge a rechargeable battery of the wearable device during a charging session, one or more processors communicatively coupled with the one or more inductive charging components, the one or more processors configured to, detect that the wearable device is coupled to the charging device, output, using the one or more inductive charging components, power to charge the wearable device during the charging session for the wearable device, the power output via the inductive charging link based at least in part on detecting that the wearable device is coupled to the charging device, output, to the wearable device via the inductive charging link as part of the charging session, charger diagnostic data associated with the one or more inductive charging components of the charging device, wherein the inductive charging link is formed using the one or more inductive charging components, and output, using the one or more inductive charging components and via the inductive charging link, additional power to charge the wearable device during the charging session based at least in part on outputting the charger diagnostic data.

In some examples of the apparatus, the power output via the inductive charging link may be associated with a first power level used to charge the wearable device during a first portion of the charging session, the additional power output via the inductive charging link may be associated with a second power level used to charge the wearable device during a second portion of the charging session, and the second power level may be greater than or equal to the first power level.

In some examples of the apparatus, the first power level may be associated with a first charging rate of the wearable device during the first portion of the charging session, the second power level may be associated with a second charging rate of the wearable device during the second portion of the charging session, and the second charging rate may be greater than or equal to the first charging rate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
detecting, at a charging device, that a wearable device is coupled to the charging device;
outputting, from the charging device, power to charge the wearable device during a charging session for the wearable device, the power output via an inductive charging link between the charging device and the wearable device based at least in part on detecting that the wearable device is coupled to the charging device;
outputting, from the charging device and to the wearable device via the inductive charging link as part of the charging session, charger diagnostic data associated with one or more inductive charging components of the charging device, wherein the inductive charging link is formed using the one or more inductive charging components; and
outputting, from the charging device and to the wearable device via the inductive charging link as part of the charging session, additional power to charge the wearable device during the charging session based at least in part on outputting the charger diagnostic data.

2. The method of claim 1, wherein the power output via the inductive charging link is associated with a first power level used to charge the wearable device during a first portion of the charging session, and wherein the additional power output via the inductive charging link is associated with a second power level used to charge the wearable device during a second portion of the charging session, wherein the second power level is greater than or equal to the first power level.

3. The method of claim 2, wherein the first power level is associated with a first charging rate of the wearable device during the first portion of the charging session, and wherein the second power level is associated with a second charging rate of the wearable device during the second portion of the charging session, wherein the second charging rate is greater than or equal to the first charging rate.

4. The method of claim 2, wherein the charger diagnostic data is output during the first portion of the charging session associated with the first power level.

5. The method of claim 1, wherein the power output via the inductive charging link is associated with a first power level used to charge the wearable device during a first portion of the charging session, and wherein the additional power output via the inductive charging link is associated with a second power level used to charge the wearable device during a second portion of the charging session, wherein the second power level is less than to the first power level.

6. The method of claim 1, further comprising:
receiving, at the charging device and from the wearable device via the inductive charging link, a request for the charger diagnostic data based at least in part on the power output via the inductive charging link between the charging device and the wearable device, wherein the charger diagnostic data is output in response to the request.

7. The method of claim 1, further comprising:
receiving, at the charging device and from the wearable device via the inductive charging link, one or more messages associated with a firmware update for the charging device based at least in part on the charger diagnostic data; and
implementing the firmware update at the charging device using one or more processors of the charging device.

8. The method of claim 1, further comprising:
outputting, from the charging device and to the wearable device via the inductive charging link, data acquired using one or more sensors of the charging device.

9. The method of claim 1, further comprising:
performing, by the charging device, one or more diagnostic procedures, wherein outputting the charger diagnostic data is based at least in part on performing the one or more diagnostic procedures.

10. The method of claim 1, wherein the charger diagnostic data comprises a firmware version of the charging device, a serial number of the charging device, a size of the charging device, a manufacturer of the charging device, a hardware version of the charging device, an input voltage of the charging device, a supply voltage associated with the one or more inductive charging components, information associated with an internal pin check, statistics associated with the charging session, or any combination thereof.

11. The method of claim 1, further comprising:
outputting, from the charging device to the wearable device via the inductive charging link as part of the charging session, sensor data acquired via one or more sensors of the charging device.

12. A method, comprising:
activating, at a wearable device, charging-based communication circuitry of the wearable device based at least in part on the wearable device being coupled to a charging device;
receiving, at the wearable device, power from the charging device via the charging-based communication circuitry during a charging session for the wearable device, the power received via an inductive charging link between the charging device and the wearable device;
recharging, at the wearable device, a battery of the wearable device using the power received via the inductive charging link;
receiving, at the wearable device and from the charging device via the inductive charging link as part of the charging session, charger diagnostic data associated with one or more inductive charging components of the charging device, wherein the inductive charging link is formed using the one or more inductive charging components; and
receiving, at the wearable device and from the charging device via the inductive charging link as part of the charging session, additional power to charge the wearable device during the charging session based at least in part on receiving the charger diagnostic data.

13. The method of claim 12, wherein the power received via the inductive charging link is associated with a first power level used to charge the wearable device during a first portion of the charging session, and wherein the additional power received via the inductive charging link is associated with a second power level used to charge the wearable device during a second portion of the charging session, wherein the second power level is greater than or equal to the first power level.

14. The method of claim 13, wherein the first power level is associated with a first charging rate of the wearable device during the first portion of the charging session, and wherein the second power level is associated with a second charging rate of the wearable device during the second portion of the charging session, wherein the second charging rate is greater than or equal to the first charging rate.

15. The method of claim 13, wherein the charger diagnostic data is received during the first portion of the charging session associated with the first power level.

16. The method of claim 12, further comprising:
outputting, from the wearable device and to the charging device and via the inductive charging link, a request for the charger diagnostic data based at least in part on receiving the power from the charging device.

17. The method of claim 12, further comprising:
outputting, from the wearable device and to the charging device and via the inductive charging link, one or more messages associated with a firmware update for the charging device based at least in part on receiving the charger diagnostic data.

18. The method of claim 12, further comprising:
receiving, at the wearable device via communication circuitry and from an application of a user device, a request for the charger diagnostic data; and
outputting, from the wearable device and to the application via the communication circuitry, the charger diagnostic data after the charging session is completed.

19. A charging device for charging a wearable device, the charging device comprising:
a charger housing configured to receive the wearable device;
one or more inductive charging components configured to form an inductive charging link with a wearable device to recharge a rechargeable battery of the wearable device during a charging session; and
one or more processors communicatively coupled with the one or more inductive charging components, the one or more processors configured to:
detect that the wearable device is coupled to the charging device;
output, using the one or more inductive charging components, power to charge the wearable device during the charging session for the wearable device, the power output via the inductive charging link based at least in part on detecting that the wearable device is coupled to the charging device;
output, to the wearable device via the inductive charging link as part of the charging session, charger diagnostic data associated with the one or more inductive charging components of the charging device, wherein the inductive charging link is formed using the one or more inductive charging components; and
output, using the one or more inductive charging components and via the inductive charging link, additional power to charge the wearable device during the charging session based at least in part on outputting the charger diagnostic data.

20. The charging device of claim 19, wherein the power output via the inductive charging link is associated with a first power level used to charge the wearable device during a first portion of the charging session, and wherein the additional power output via the inductive charging link is associated with a second power level used to charge the wearable device during a second portion of the charging session, wherein the second power level is greater than or equal to the first power level.
